(19) United States
(12) Patent Application Publication
(10) Pub. No.: US 2025/0227610 A1
(43) Pub. Date: Jul. 10, 2025

(54) METHOD AND APPARATUS FOR SAVING ENERGY IN A WIRELESS COMMUNICATION SYSTEM

(71) Applicant: SAMSUNG ELECTRONICS CO., LTD., Suwon-si (KR)

(72) Inventors: Junyung YI, Suwon-si (KR); Youngbum KIM, Suwon-si (KR); Younsun KIM, Suwon-si (KR); Jaewon LEE, Suwon-si (KR)

(21) Appl. No.: 19/016,236

(22) Filed: Jan. 10, 2025

(30) Foreign Application Priority Data
Jan. 10, 2024 (KR) 10-2024-0004353

(51) Int. Cl. H04W 52/02; H04W 56/00; H04W 72/231

(52) U.S. Cl. CPC H04W 52/0206; H04W 56/0015; H04W 72/231

(57) ABSTRACT

Provided is a method performed by a user equipment (UE) in a wireless communication system, including receiving, from a base station, configuration information regarding an on-demand operation for at least one secondary cell, identifying that an on-demand operation of a secondary cell among the at least one secondary cell is triggered, and receiving an on-demand synchronization signal block (SSB) of the secondary cell, based on the configuration information.

### CROSS-REFERENCE TO RELATED APPLICATION

This application is based on and claims priority under 35 U.S.C. § 119 to Korean Patent Application No. 10-2024-0004353, filed on Jan. 10, 2024, in the Korean Intellectual Property Office, the disclosure of which is incorporated by reference herein in its entirety.

### BACKGROUND

### 1. Field

The disclosure relates to operations of a terminal and a base station in a wireless communication system. More particularly, the disclosure relates to a method and apparatus for saving energy in a wireless communication system.

### 2. Description of the Related Art

5th generation (5G) mobile communication technology defines a wide frequency band to enable a fast transmission speed and a new service, and is implemented not only in a sub 6 gigahertz (GHz) frequency band, such as 3.5 GHz, but also in an above 6 GHz ultra-high frequency band referred to as millimeter wave (mmWave), such as 28 GHz and 39 GHz. Also, in 6th generation (6G) mobile communication technology also referred to as a beyond 5G system, implementation in a terahertz (THz) band (e.g., a 3 THz in 95 GHz) is considered to achieve a transmission speed 50 times faster than 5G mobile communication technology and an ultra-low latency time reduced to 1/10 of 5G mobile communication technology.

In early stages of 5G mobile communication technology, standardization has been performed on beamforming and massive multiple-input multiple-output (MIMO) for alleviating a pass loss of radio waves and increasing a transmission distance of radio waves in an ultra-high frequency band, support of various numerologies (an operation of a plurality of subcarrier intervals) and a dynamic operation of slot formats for efficient use of ultra-high frequency resources, initial access technology for supporting multi-bean transmission and wideband, definition and operation of a bandwidth part (BWP), a new channel coding method, such as polar code, for highly reliable transmission of control information and low density parity check (LDPC) code for massive data transmission, L2 pre-processing, and network slicing providing a dedicated network specialized for a specific service, targeting at service support and performance requirement satisfaction for enhanced mobile broadband (eMBB), ultra-reliable low-latency communications (URLLC), and massive machine-type communications (mMTC).

Currently, discussions are being held to improve and enhance initial 5G mobile communication technology in consideration of services that were to be supported by 5G mobile communication technology, and physical layer standardization is being performed on vehicle-to-everything (V2X) for assisting driving determination of an autonomous vehicle and increasing user convenience, based on its location and status information transmitted by the vehicle, new radio unlicensed (NR-U) targeting at a system operation matching various regulatory requirements in an unlicensed band, NR user equipment (UE) low power consumption technology (UE power saving), non-terrestrial network (NTN) that is direct UE-satellite communication for coverage securement in areas where communication with terrestrial networks is impossible, and positioning.

In addition, standardization of wireless interface architectures/protocols is being performed for industrial Internet of things (IIoT) for supporting new services through linkage and convergence with other industries, integrated access and backhaul (IAB) providing nodes for expanding network service areas by integrally supporting wireless backhaul links and access links, mobility enhancement including conditional handover and dual active protocol stack (DAPS) handover, and 2-step random access channel (RACH) for NR for simplifying random access procedures, and standardization of system architectures/services is also being performed for 5G baseline architectures (e.g., service-based architectures and service-based interfaces) for grafting network functions virtualization (NFV) onto software-defined networking (SDN) technology, and mobile edge computing (MEC) for receiving services based on locations of UEs.

When such a 5G mobile communication system is commercialized, connected devices that have been explosively increased may be connected to a communication network and accordingly, it is anticipated that functions and performance of the 5G mobile communication system need to be reinforced and the connected devices need to be integrally operated. In this regard, new studies will be conducted on extended reality (XR) for efficiently supporting augmented reality (AR), virtual reality (VR), and mixed reality (MR), 5G performance improvement and complexity reduction using artificial intelligence (AI) and machine learning (ML), AI service support, metaverse service support, and drone communication.

Such development of a 5G mobile communication system may serve as the basis for development of not only multi-antenna transmission technology, such as new waveform, full dimensional (FD)-MIMO, array antenna, and large scale antenna, for coverage securement in THz band of 6G mobile communication technology, higher-dimensional space multiplexing technology using metamaterial-based lens and antenna and orbital angular momentum (OAM) for improving coverage of a THz band signal, and reconfigurable intelligent surface (RIS) technology, but also full duplex technology for improving frequency efficiency and enhancing a system network of 6G mobile communication technology, AI-based communication technology that uses a satellite and AI from a design stage and realizes system optimization by internalizing end-to-end AI support function, and next-generation distributed computing technology that realizes a service with complexity exceeding limits of UE computing capability by using ultra-high performance communication and computing resources.

With the recent development of 5G/6G communication systems considering an environment, the need for a method of reducing energy consumption of a communication system (e.g., a terminal, a base station, or a network) or a method of saving energy thereof has emerged.

### SUMMARY

Provided are a configuration method for on-demand synchronization signal block (SSB) transmission and an on-demand SSB transmission method for reducing energy consumption of a base station in a wireless communication system.

Provided are configuration method through higher layer signaling (e.g., radio resource control (RRC) signaling) for applying an on-demand operation, and a method of activating and deactivating an on-demand operation through higher layer signaling and L1 signaling. In addition, provided is an on-demand SSB transmission method for a base station, according to an uplink signal from a terminal and determination of the base station.

Additional aspects will be set forth in part in the description which follows and, in part, will be apparent from the description, or may be learned by practice of the presented embodiments of the disclosure.

According to an embodiment of the disclosure, a method performed by a user equipment (UE) in a wireless communication system, includes receiving, from a base station, configuration information regarding an on-demand operation for at least one secondary cell, identifying that an on-demand operation of a secondary cell among the at least one secondary cell is triggered, and receiving an on-demand synchronization signal block (SSB) of the secondary cell, based on the configuration information.

According to an embodiment of the disclosure, a method performed by a base station in a wireless communication system, includes transmitting, to a user equipment, configuration information regarding an on-demand operation for at least one secondary cell, and transmitting an on-demand synchronization signal block (SSB) of a secondary cell, among the at least one secondary cell, based on the configuration information.

According to an embodiment of the disclosure, a user equipment (UE) in a wireless communication system, includes a transceiver and at least one processor coupled with the transceiver and configured to receive, from a base station, configuration information regarding an on-demand operation for at least one secondary cell, identify that an on-demand operation of a secondary cell among the at least one secondary cell is triggered, and receive an on-demand synchronization signal block (SSB) of the secondary cell, based on the configuration information.

According to an embodiment of the disclosure, a base station in a wireless communication system, includes a transceiver and at least one processor coupled with the transceiver and configured to transmit, to a user equipment, configuration information regarding an on-demand operation for at least one secondary cell, and transmit an on-demand synchronization signal block (SSB) of a secondary cell, among the at least one secondary cell, based on the configuration information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a base structure of a time-frequency domain that is a radio resource domain in a wireless communication system according to an embodiment of the disclosure;

FIG. 2 illustrates an example of a slot structure considered in a wireless communication system according to an embodiment of the disclosure;

FIG. 3 illustrates an example of a time domain mapping structure of a synchronization signal and a beam sweeping operation according to an embodiment of the disclosure;

FIG. 4 illustrates an example of a synchronization signal block considered in a wireless communication system according to an embodiment of the disclosure;

FIG. 5 illustrates examples of various transmission cases of a synchronization signal block in a frequency band of less than 6 GHz according to an embodiment of the disclosure;

FIG. 6 illustrates examples of transmission cases of a synchronization signal block in a frequency band of 6 GHz or more according to an embodiment of the disclosure;

FIG. 7 illustrates examples transmission cases of a synchronization signal block according to a subcarrier spacing within a time of 5 ms in a wireless communication system according to an embodiment of the disclosure;

FIG. 8 illustrates examples for describing DMRS patterns (type 1 and type 2) used for a communication between a base station and a terminal in a wireless communication system according to an embodiment of the disclosure;

FIG. 9 illustrates an example of channel estimation using a DMRS received on a PUSCH in a time band of a wireless communication system according to an embodiment of the disclosure;

FIG. 10 illustrates an example of a method for reconfiguring SSB transmission through a dynamic signaling of a wireless communication system according to an embodiment of the disclosure;

FIG. 11 illustrates an example of a method for reconfiguring a BWP and a BW through a dynamic signaling of a wireless communication system according to an embodiment of the disclosure;

FIG. 12 illustrates an example of a method for reconfiguring DRX through a dynamic signaling of a wireless communication system according to an embodiment of the disclosure;

FIG. 13 illustrates an example for describing a DTX for saving energy of a base station according to an embodiment of the disclosure;

FIG. 14 illustrates an example for describing an operation of a base station including a gNB wake-up signal according to an embodiment of the disclosure;

FIG. 15 illustrates an example of an antenna adaptation method for a base station for saving energy in a wireless communication system according to an embodiment of the disclosure;

FIG. 16 illustrates an example of on-demand SSB operations of a base station and terminal according to an embodiment of the disclosure;

FIG. 17 illustrates an example of a SCell activation/deactivation and an on-demand SSB configuration method for a base station according to an embodiment of the disclosure;

FIG. 18 illustrates an example of a MAC CE-based SCell activation/deactivation and an on-demand SSB configuration method for a base station according to an embodiment of the disclosure;

FIG. 19A illustrates an example of on-demand SSB operations and SSB transmission patterns of a base station and a terminal according to an embodiment of the disclosure;

FIG. 19B illustrates an example of on-demand SSB operations and SSB transmission patterns of a base station and a terminal according to an embodiment of the disclosure;

FIG. 20 illustrates an example of a flowchart of a terminal for an energy saving method of a wireless communication system according to an embodiment of the disclosure;

FIG. 21 illustrates an example of a flowchart of a base station for an energy saving method of a wireless communication system according to an embodiment of the disclosure;

FIG. 22 illustrates an example of a terminal according to an embodiment of the disclosure; and

FIG. 23 illustrates an example of a base station according to an embodiment of the disclosure.

### DETAILED DESCRIPTION

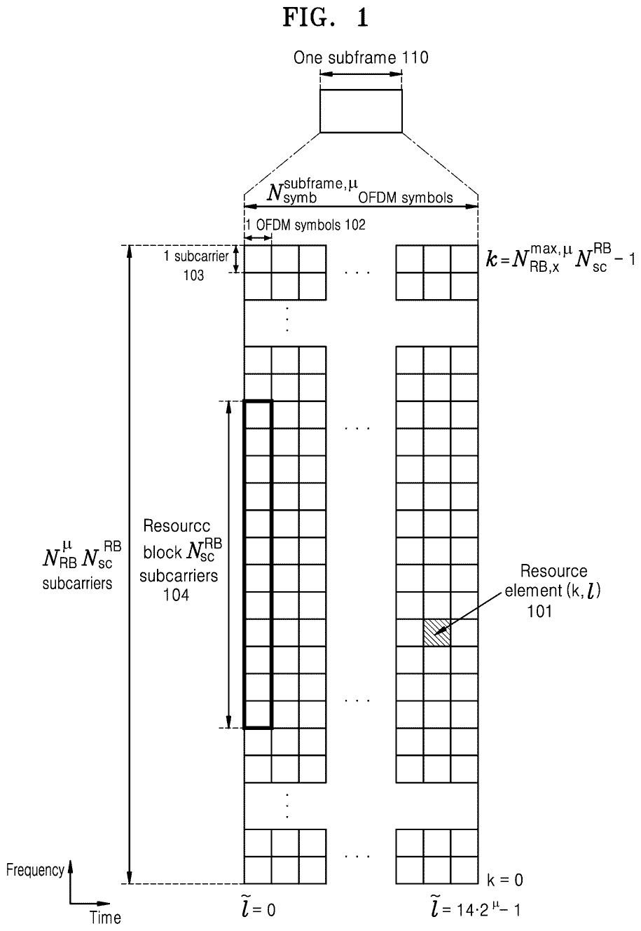

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described with reference to accompanying drawings. In describing embodiments of the disclosure, descriptions of technical contents that are well known in the technical field to which the disclosure belongs and are not directly related to the disclosure will be omitted. By omitting the unnecessary description, the gist of the disclosure may be more clearly conveyed without obscuring the subject matter.

For the same reasons, some elements are exaggerated, omitted, or schematically illustrated in drawings. Also, the size of each component does not completely reflect the actual size. In the drawings, like elements are denoted by like reference numerals.

The advantages and features of the disclosure and methods of achieving them will become apparent with reference to embodiments of the disclosure described in detail below with reference to the accompanying drawings. In this regard, embodiments of the disclosure may have different forms and should not be construed as being limited to the descriptions set forth herein. Rather, these embodiments of the disclosure are provided so that the disclosure will be thorough and complete and will fully convey the concept of the disclosure to one of ordinary skill in the art, and the disclosure will only be defined by the appended claims. Throughout the specification, like reference numerals denote like elements. While describing the disclosure, detailed description of related well-known functions or configurations may be omitted when it is deemed that they may unnecessarily obscure the essence of the disclosure. Also, terms used below are defined in consideration of functions in the disclosure, and may have different meanings according to an intention of a user or operator, customs, or the like. Therefore, the terms used herein have to be defined based on the meaning of the terms together with the description throughout the specification.

Throughout the disclosure, the expression “at least one of a, b, and c” indicates only a, only b, only c, both a and b, both a and c, both b and c, all of a, b, and c, or variations thereof.

Throughout the specification, a layer may also be referred to as an entity.

Hereinafter, a base station (BS) is an entity that allocates resources to a terminal, and may be at least one of a gNode B (gNB), an eNode B (eNB), a Node B (NB), a wireless access unit, a BS controller, or a node on a network. Examples of a terminal may include user equipment (UE), a mobile station (MS), a cellular phone, a smartphone, a computer, and a multimedia system capable of performing a communication function. In the disclosure, a downlink (DL) is a wireless transmission path of a signal transmitted from a base station to a terminal, and an uplink (UL) is a wireless transmission path of a signal transmitted from a terminal to a base station. Also, hereinbelow, a long-term evolution (LTE) or long-term evolution advanced (LTE-A) system may be described as an example, but an embodiment of the disclosure may also be applied to other communication systems having a similar technical background or channel form. An example of the other communication may include a 5th generation mobile communication technology (5G or new radio (NR)) developed after LTE-A, and hereinafter, 5G may have a concept including existing LTE, LTE-A, and another similar service. Also, it will be understood by one of ordinary skill in the art that the disclosure may be applied to other communication systems through some modifications without departing from the scope of the disclosure.

It will be understood that blocks in flowcharts or combinations of the flowcharts may be performed by computer program instructions. Because these computer program instructions may be loaded into a processor of a general-purpose computer, special purpose computer, or other programmable data processing apparatus, the instructions, which are executed via the processor of the computer or other programmable data processing apparatus generate means for implementing the functions specified in the flowchart block(s). The computer program instructions may be stored in a computer-executable or computer-readable memory capable of directing a computer or another programmable data processing apparatus to implement a function in a particular manner, and thus the instructions stored in the computer-executable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated successively may actually be executed substantially concurrently, or the blocks may sometimes be performed in a reverse order according to the corresponding function.

The term “unit” or “-er/or” used in the disclosure denotes a software element or a hardware element such as a field-programmable gate array (FPGA) or an application-specific integrated circuit (ASIC), and performs a certain function. However, the term “unit” or “-er/or” is not limited to software or hardware. The “unit” or “-er/or” may be formed so as to be in an addressable storage medium, or may be formed so as to operate one or more processors. Thus, for example, the term “unit” or “-er/or” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” or “-ers/ors” may be associated with the smaller number of components and “units” or “-ers/ors,” or may be divided into additional components and “units” “-ers/ors.” Furthermore, the components and “units” or “-ers/ors” may be embodied to reproduce one or more central processing units (CPUs) in a device or security multimedia card. Also, in an embodiment of the disclosure, the “unit” or “-er/or” may include at least one processor.

Hereinafter, embodiments of the disclosure will be described in detail with reference to accompanying drawings. Methods and apparatuses provided in embodiments of the disclosure are not limitedly applied to each embodiment of the disclosure, but may be used as a combined embodiment of the disclosure of all or some embodiments of the disclosure. Accordingly, embodiments of the disclosure may be applied through modification at the discretion of one of ordinary skill in the art without greatly departing from the scope of the disclosure.

While describing the disclosure, detailed description of related well-known functions or configurations may be omitted when it is deemed that they may unnecessarily obscure the essence of the disclosure. Also, terms used below are defined in consideration of functions in the disclosure, and may have different meanings according to an intention of a user or operator, customs, or the like. Therefore, the terms used herein have to be defined based on the meaning of the terms together with the description throughout the specification.

Wireless communication systems have been developed from wireless communication systems providing voice centered services in the early stage toward broadband wireless communication systems providing high-speed, high-quality packet data services, like communication standards of high speed packet access (HSPA), long term evolution (LTE or evolved universal terrestrial radio access (E-UTRA)), LTE-advanced (LTE-A), and LTE-Pro of the 3GPP, high rate packet data (HRPD) and ultra-mobile broadband (UMB) of 3GPP2, or IEEE 802.17e.

As a representative example of the broadband wireless communication system, the LTE system has adopted an orthogonal frequency division multiplexing (OFDM) scheme in a downlink (DL) and has adopted a single carrier frequency division multiple access (SC-FDMA) scheme in an uplink (UL). The UL refers to a radio link through which a terminal (hereinafter, referred to as a UE) (or MS) transmits data or a control signal to a base station (eNode B (eNB) or BS), and the DL refers to a radio link through which a base station transmits data or a control signal to a UE. In a multiple access scheme described above, data or control information of each user is classified by generally allocating and managing the data or control information such that time-frequency resources for transmitting data or control information for each user do not overlap each other, that is, such that orthogonality is established.

A 5G communication system that is a beyond LTE communication system needs to support services that simultaneously satisfy various requirements so that the various requirements of users and service providers are freely reflected. The services considered for the 5G communication system include enhanced mobile broadband (eMBB), massive machine type communication (mMTC), or ultra-reliability low latency communication (hereinafter, URLLC).

The eMBB aims to provide a higher data transfer rate than a data transfer rate supported by the LTE, LTE-A, or LTE-Pro system. For example, in the 5G communication system, the eMBB should be able to provide a peak data rate of 20 Gbps in a downlink and a peak data rate of 10 Gbps in an uplink from the viewpoint of one base station. In addition, the 5G communication system needs to provide the increased user perceived data rate of the UE simultaneously with providing the peak data rate. In order to satisfy such requirements, improvement of various transmitting/receiving technologies including a further improved multiple-input and multiple-output (MIMO) transmission technology may be demanded. In addition, signals are transmitted using a transmission bandwidth of up to 20 MHz in a 2 GHz band in an LTE system, but the 5G communication system uses a bandwidth wider than 20 MHz in a frequency band of 3 GHz to 6 GHz or more than 6 GHZ, thereby satisfying a data rate required in the 5G communication system.

At the same time, the mMTC is being considered to support application services such as Internet of things (IoT) in the 5G communication system. The mMTC requires an access support of a large-scale UE in a cell, coverage enhancement of a UE, improved battery time, and cost reduction of a UE in order to efficiently provide the IoT. The IoT needs to be able to support a large number of UEs (e.g., 1,000,000 UEs/km²) in a cell because the IoT is attached to various sensors and various devices to provide communication functions. In addition, the UEs supporting the mMTC are more likely to be positioned in shaded areas not covered by a cell, such as the underground of a building due to nature of services, and thus, the UE requires a wider coverage than other services provided by the 5G communication system. The UEs that support the mMTC should be configured as inexpensive UEs and require very long battery lifetime, such as 10 years to 16 years, because it is difficult to frequently replace batteries of the UEs.

Lastly, the URLLC is a cellular-based wireless communication system used for a specific purpose (mission-critical). For example, a service used in remote control for a robot or machinery, industrial automation, unmanned aerial vehicle, remote health care, or emergency alert may be considered. Accordingly, communication provided by the URLLC should provide very low latency and very high reliability. For example, a service supporting the URLLC should satisfy air interface latency smaller than 0.5 milliseconds and at the same time, may have a requirement for a packet error rate of 105 or less. Accordingly, for URLLC-supportive services, the 5G communication system is required to provide a transmit time interval (TTI) shorter than those for other services while securing reliable communication links by assigning a broad resource in a frequency band.

The three services, that is, eMBB, URLLC, and mMTC, in the above 5G communication system may be multiplexed in one system and may be transmitted. The services may use different transmission and reception methods and transmission and reception parameters in order to meet their different requirements.

Hereinafter, a frame structure of a 5G system will be described in detail with reference to accompanying drawings. Hereinafter, a wireless communication system to which the disclosure is applied will be described with an example of a configuration of a 5G system for convenience of description, but embodiments of the disclosure may be applied to beyond 5G systems or other communication systems, to which the disclosure is applicable, in a same or similar manner.

FIG. 1 illustrates an example of a base structure of a time-frequency domain that is a radio resource domain in a wireless communication system according to an embodiment of the disclosure.

In FIG. 1, a horizontal axis represents a time domain and a vertical axis represents a frequency domain. In the time and frequency domains, a base unit of a resource is a resource element (RE) 101, and may be defined by one OFDM symbol 102 (or a discrete Fourier transform spread OFDM (DFT-s-OFDM) symbol on a time axis and one subcarrier 103 on a frequency axis. In the frequency domain, N_{SC}^{RB} (e.g., 12) consecutive REs indicating the number of subcarriers per resource block (RB) may configure one RB 104. Also, N_{symb}^{subframe,μ} consecutive OFDM symbols indicating the number of symbols per subframe according to a configuration value μ for a subcarrier spacing in the time domain may configure one subframe 110.

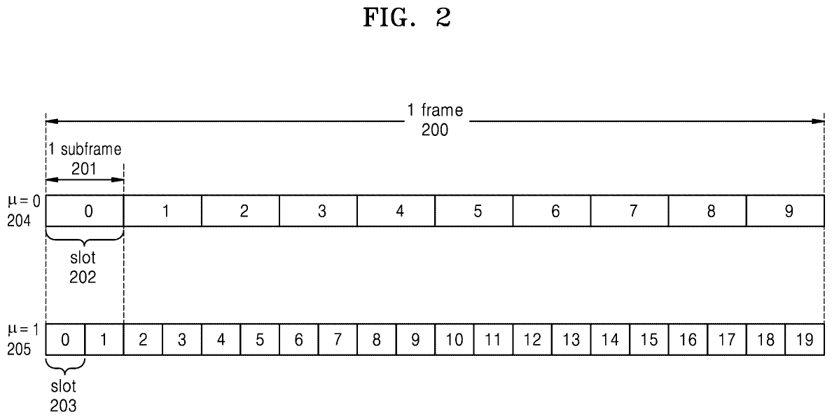

FIG. 2 illustrates an example of a slot structure according to an embodiment of the disclosure.

FIG. 2 illustrates an example of the slot structure including a frame 200, subframes 201, and slots 202 or 203. One frame 200 may be defined to be 10 ms. One subframe 201 may be defined to be 1 ms, and accordingly, one frame 200 may include total 10 subframes slot 201. One slot 202 or 203 may be defined by 14 OFDM symbols (i.e., the number (N_{symb}^{slot}) of symbols per slot=14). One subframe 201 may include one slot 202 or a plurality of slots (e.g., the slots 203) and the number of slots per subframe 201 may vary depending on u 204 or 205n that is a configuration value for a subcarrier spacing (SCS).

The slot structures where the configuration value u 204 for SCS is 0 and where the configuration value u 205 for SCS is 1 are illustrated. When the configuration value u 204 is 0, one subframe 201 may include one slot 202, and when the configuration value u 205 is 1, one subframe 201 may include two slots (e.g., the slots 203). In other words, the number (N_{symb}^{subframe,μ}) of slots per subframe may vary depending on a configuration value μ for SCS, and accordingly, the number (N_{symb}^{frame,μ}) of slots per frame may vary. For example, N_{symb}^{subframe,μ} and N_{symb}^{frame,μ} according to the configuration value μ for each SCS may be defined as Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In a 5G wireless communication system, a synchronization signal block (SSB) (interchangeably used as SS block or synchronization signal (SS)/physical broadcast channel (PBCH) block) may be transmitted for an initial access of a UE, and the SSB may include a primary synchronization signal (PSS), a secondary synchronization signal (SSS), and a PBCH.

During the initial access in which the UE accesses a system, the UE may first obtain a downlink time and frequency domain synchronization from a synchronization signal through a cell search and obtain a cell identification (ID). The synchronization signal may include a PSS and an SSS. Then, the UE may receive, from a base station, a PBCH transmitting a master information block (MIB) and obtain a base parameter value and transmission/reception-related system information such as a system bandwidth or related control information. The UE may perform decoding on a physical downlink control channel (PDCCH) and a physical downlink shared channel (PDSCH) based on such information and obtain a system information block (SIB). Then, through a random access, the UE may exchange identification-related information of the UE with the base station and initially access a network through registration and authentication. In addition, the UE may obtain cell common transmission/reception-related control information by receiving system information (SIB) transmitted by the base station. The cell common transmission/reception-related control information may include random access-related control information, paging-related control information, and common control information for various physical channels.

The synchronization signal is a signal that is a basis of the cell search and an SCS may be applied to the synchronization signal to be suitable for a channel environment, such as phase noise, for each frequency band. Different SCSs may be applied to a data channel or a control channel according to a service type so as to support various services as described above.

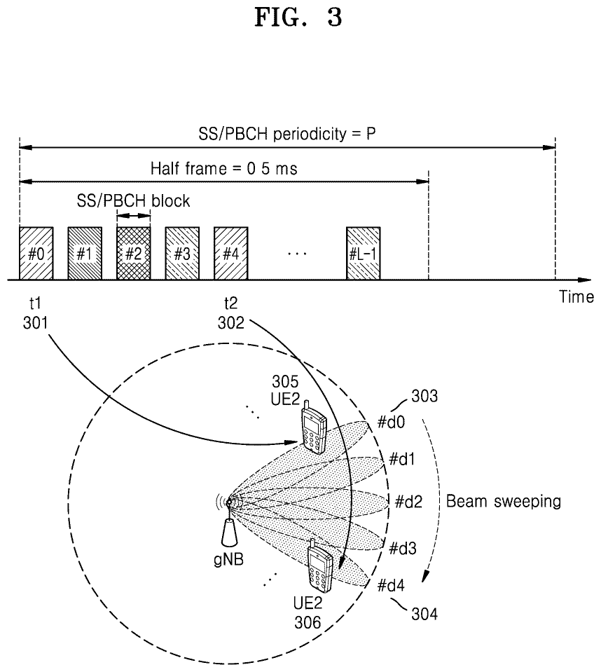

FIG. 3 illustrates an example of a time domain mapping structure of a synchronization signal and a beam sweeping operation according to an embodiment of the disclosure.

For description, following elements may be defined.
PSS: A signal that is a basis of DL time/frequency synchronization and provides some information of a cell ID.
SSS: A signal that is a basis of DL time/frequency synchronization and provides remaining information of the cell ID. Additionally, the SSS may serve as a reference signal for demodulation of a PBCH.
PBCH: Provides an MIB that is essential system information required for data channel and control channel transmission/reception of a UE. The essential system information may include search space-related control information indicating radio resource mapping information, scheduling control information about a separate data channel transmitting system information, and information about a system frame number (SFN) that is a frame unit index serving as a timing reference.
SS/PBCH block: An SS/PBCH block includes N OFDM symbols and is configured with a combination of PSS, SSS, and PBCH. In a system to which a beam sweeping technology is applied, an SS/PBCH block is a minimum unit to which beam sweeping is applied. In a 5G system, N may be 4. A base station may transmit up to L SS/PBCH blocks wherein the L SS/PBCH blocks are mapped onto a half frame (0.5 ms). Also, the L SS/PBCH blocks are periodically repeated in units of certain periodicity P. The periodicity P may be notified by a base station to a UE through signaling. When there is no separate signaling for the periodicity P, the UE applies a pre-agreed default value.

FIG. 3 illustrates an example in which beam sweeping is applied in units of SS/PBCH blocks according to time. In the example of FIG. 3, a first UE 305 receives an SS/PBCH block by using a beam radiated in a direction #d0 303 according to beamforming applied to an SS/PBCH block #0 at a time point t1 301. Also, a second UE 306 receives an SS/PBCH block by using a beam radiated in a direction #d4 304 according to beamforming applied to an SS/PBCH block #4 at a time point t2 302. A UE may obtain an optimum synchronization signal through a beam radiated in a direction from a base station towards the UE. For example, it may be difficult for the first UE 305 to obtain time/frequency synchronization and essential system information from an SS/PBCH block through a beam radiated in the direction #d4 304 that is far away from the first UE 305.

In addition to an initial access procedure, a UE may receive an SS/PBCH block to determine whether radio link quality of a current cell is maintained a certain level or more. Also, during a handover procedure in which a UE moves from a current cell to an adjacent cell, the UE may receive an SS/PBCH block of the adjacent cell to determine radio link quality of the adjacent cell and obtain time/frequency synchronization of the adjacent cell.

Hereinafter, a cell initial access procedure of a 5G wireless communication system will be described in more detail with reference to the drawings.

A synchronization signal is a signal serving as a basis of a cell search and may be transmitted after SCS suitable for a channel environment (e.g., phase noise) is applied thereto for each frequency band. A 5G base station may transmit a plurality of SS blocks according to the number of analog beams to be operated. For example, PSS and SSS may be mapped onto 12 RBs and transmitted, and PBCH may be mapped onto 24 RBs and transmitted. Hereinafter, a structure in which a synchronization signal and PBCH are transmitted in a 5G communication system will be described.

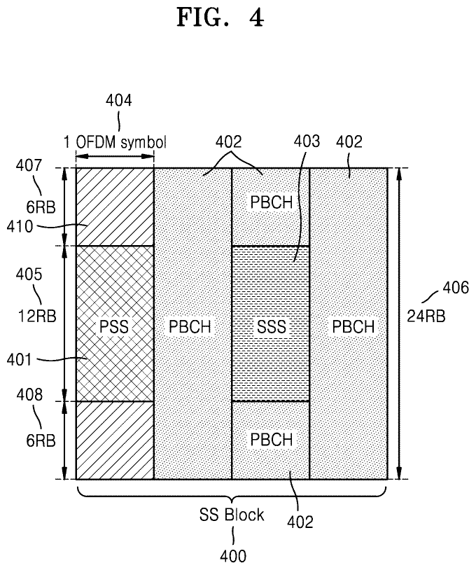

FIG. 4 illustrates an example of an SS block 400 according to an embodiment of the disclosure.

Referring to FIG. 4, the SS block 400 may include PSS 401, SSS 403, and PBCH 402.

The SS block 400 may be mapped onto four OFDM symbols 404 on a time axis. The PSS 401 and the SSS 403 may be transmitted on 12 RBs 405 in a frequency axis and respectively on first and third OFDM symbols in a time axis. In a 5G system, for example, a total of 1008 different cell IDs may be defined. The PSS 401 may have 3 different values and the SSS 403 may have 336 different values depending on a physical cell ID (PCI). A UE may obtain one of the (336×3=) 1008 cell IDs by detecting and combining the PSS 401 and the SSS 403. This may be represented by Equation 1 below.

$${N}_{ID}^{cell} = 3 {N}_{ID}^{( 1 )} + {N}_{ID}^{( 2 )} . \qquad 〈 Equation 1 〉$$

In Equation 1, N_{ID}⁽¹⁾ may be estimated from the SSS 403 and have a value between 0 and 335. N_{ID}⁽²⁾ may be estimated from the PSS 401 and have a value between 0 and 2. The UE may estimate a value of N_{ID}^{(cell)} that is a cell ID by using a combination of N_{ID}⁽¹⁾ and N_{ID}⁽²⁾.

The PBCH 402 may be transmitted on 24 RBs 406 in the frequency axis and on resources excluding the middle 12 RBs 405, on which the SSS 403 is transmitted, from second to fourth OFDM symbols of the SS block 400, in the time axis. 6 RBs 407 and 408 on both sides excluding the 12 RBs 405, on which the SSS 403 is transmitted, from the third OFDM symbol of the SS block 400, may be included in transmission of the PBCH 402. The PBCH 402 may include a PBCH payload and a PBCH demodulation reference signal (DMRS), and various pieces of system information referred to as MIB may be transmitted on the PBCH payload. For example, MIB may include information as shown in Table 2 below.

TABLE 2

| | |
|---|---|
| MIB ::= | SEQUENCE { |
| systemFrameNumber | BIT STRING (SIZE (6)), |
| subCarrierSpacingCommon | ENUMERATED {scs15or60, ses30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

SSB information: An offset of a frequency domain of SSB may be indicated through ssb-SubcarrierOffset of 4 bits in MIB. An index of the SSB including PBCH may be indirectly obtained through decoding of PBCH DMRS and the PBCH. According to an embodiment of the disclosure, in a frequency band of less than 6 GHz, 3 bits obtained through the decoding of the PBCH DMRS may indicate the index of the SSB, and in a frequency band of 6 GHz or more, 3 bits obtained through the decoding of the PBCH DMRS and 3 bits obtained through the decoding of the PBCH included in a PBCH payload, i.e., total 6 bits, may indicate the index of the SSB including the PBCH.
Physical downlink control channel (PDCHH) configuration information: SCS of a common downlink control channel may be indicated through 1 bit (subCarrierSpacingCommon) in MIB, and time-frequency resource configuration information of a control resource set (CORESET) and search space (SS) may be indicated through 8 bits (pdcch-ConfigSIB1).
System frame number (SFN): 6 bits (systemFrameNumber) in MIB may be used to indicate a portion of SFN. 4 bits of least significant bit (LSB) of the SFN may be included in a PBCH payload and a UE may indirectly obtain the same through decoding of PBCH.
Timing information in radio frame: A UE may indirectly identify whether SSB has been transmitted on a first or second half frame of a radio frame by using an index of the SSB described above and 1 bit (half frame) obtained through decoding of a PBCH included in a PBCH payload.

Because transmission bandwidths (12 RBs 405) of the PSS 401 and SSS 403 are different from a transmission bandwidth (24 RBs 406) of the PBCH 402, there are the 6 RBs 407 and 408 on both sides excluding the middle 12 RBs on which the PSS 401 is transmitted, in the first OFSM symbol in which the PSS 401 is transmitted in the transmission bandwidth of the PBCH 402, and such areas may be used to transmit another signal or may be empty.

The SS blocks may be transmitted by using a same analog beam. For example, the PSS 401, the SSS 403, and the PBCH 402 may be transmitted via a same beam. The analog beam has a characteristic of not being able to be differently applied in a frequency axis, and thus, a same analog beam may be applied in all RBs in the frequency axis for a specific OFDM symbol to which a specific analog beam is applied. For example, 4 OFDM symbols in which the PSS 401, the SSS 403, and the PBCH 402 are transmitted may be transmitted via a same analog beam.

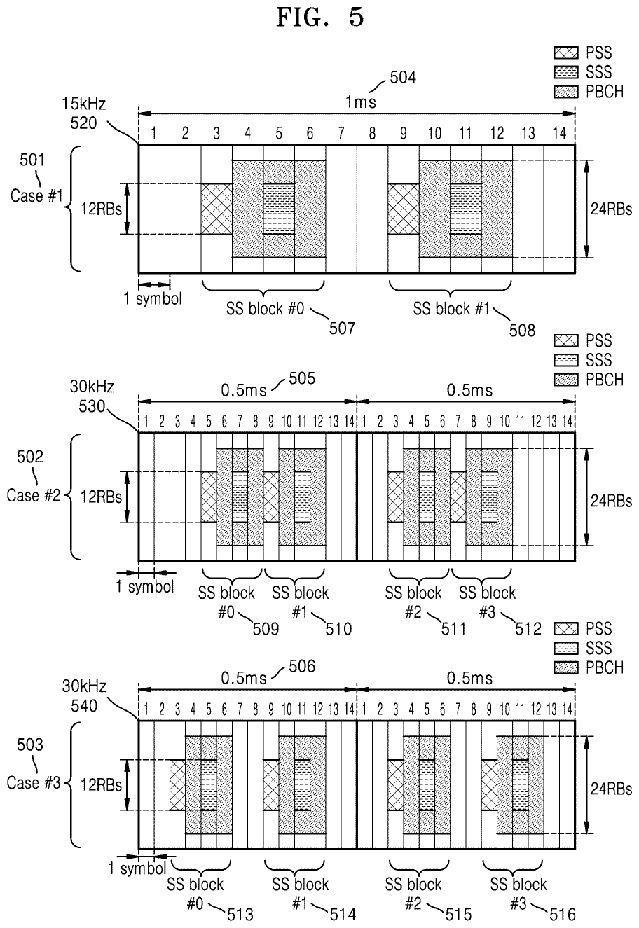

FIG. 5 illustrates examples of various transmission cases of an SS block in a frequency band of less than 6 GHz according to an embodiment of the disclosure.

Referring to FIG. 5, in a 5G communication system, SCS 520 of 15 kHz and SCSs 530 and 540 of 30 kHz may be used for SSB transmission in a frequency band of 6 GHz or less (or frequency range (FR) 1, e.g., 410 MHz to 7125 MHz). There may be one transmission case (e.g., a case #1 501) for SSB in the SCS 520 of 15 kHz, and there may be two transmission cases (e.g., a case #2 502 and a case #3 503) for SSB in the SCSs 530 and 540 of 30 kHz.

In FIG. 5, maximum two SS blocks may be transmitted within a time of 1 ms 504 (or a length of one slot when one slot includes 14 OFDM symbols) in the case #1 501 of the SCS 520 of 15 kHz. The example of FIG. 5 illustrates an SS block #0 507 and an SS block #1 508. For example, the SS block #0 507 may be mapped onto 4 consecutive symbols from a third OFDM symbol, and the SS block #1 508 may be mapped onto 4 consecutive symbols from a ninth OFDM symbol.

Different analog beams may be applied to the SS block #0 507 and the SS block #1 508. Also, a same beam may be applied to the third to sixth OFDM symbols onto which the SS block #0 507 is mapped, and a same beam may be applied to the ninth to twelfth OFDM symbols onto which the SS block #1 508 is mapped. A base station may freely determine which analog beam to use for 7th, 8th, 13th, and 14th OFDM symbols onto which an SS block is not mapped.

In FIG. 5, maximum two SS blocks may be transmitted within a time of 0.5 ms 505 (or a length of one slot when one slot includes 14 OFDM symbols) in the case #2 502 in the SCS 530 of 30 kHz, and accordingly, maximum four SS blocks may be transmitted within a time of 1 ms (or a length of two slots when one slot includes 14 OFDM symbols). The example of FIG. 5 illustrates a case in which an SS block #0 509, an SS block #1 510, and an SS block #2 511, and an SS block #3 512 are transmitted within a time of 1 ms (i.e., two slots). The SS block #0 509 and the SS block #1 510 may be respectively mapped onto fifth and ninth OFDM symbols of a first slot, and the SS block #2 511 and the SS block #3 512 may be respectively mapped onto third and seventh OFDM symbols of a second slot.

Different analog beams may be applied to the SS block #0 509, the SS block #1 510, the SS block #2 511, and the SS block #3 512. Also, a same analog beam may be applied to 5th to 8th OFDM symbols of a first slot on which the SS block #0 509 is transmitted, 9th to 12th OFDM symbols of the first slot on which the SS block #1 510 is transmitted, 3rd to 6th symbols of a second slot on which the SS block #2 511 is transmitted, and 7th to 10th symbols of the second slot on which the SS block #3 512 is transmitted. The base station may freely determine which analog beam to use for OFDM symbols onto which an SS block is not mapped.

In FIG. 5, maximum two SS blocks may be transmitted within a time of 0.5 ms 506 (or a length of one slot when one slot includes 14 OFDM symbols) in the case #3 503 in the SCS 540 of 30 kHz, and accordingly, maximum four SS blocks may be transmitted within a time of 1 ms (or a length of two slots when one slot includes 14 OFDM symbols). The example of FIG. 5 illustrates a case in which an SS block #0 513, an SS block #1 514, an SS block #2 515, and an SS block #3 516 are transmitted within a time of 1 ms (i.e., two slots). The SS block #0 513 and the SS block #1 514 may be respectively mapped onto third and ninth OFDM symbols of a first slot, and the SS block #2 515 and the SS block #3 516 may be respectively mapped onto third and ninth OFDM symbols of a second slot.

Different analog beams may be used for the SS block #0 513, the SS block #1 514, the SS block #2 515, and the SS block #3 516. As described in the above examples, a same analog beam may be used in all four OFDM symbols in which an SS block is transmitted, and the base station may determine which beam to use for OFDM symbols onto which an SS block is not mapped.

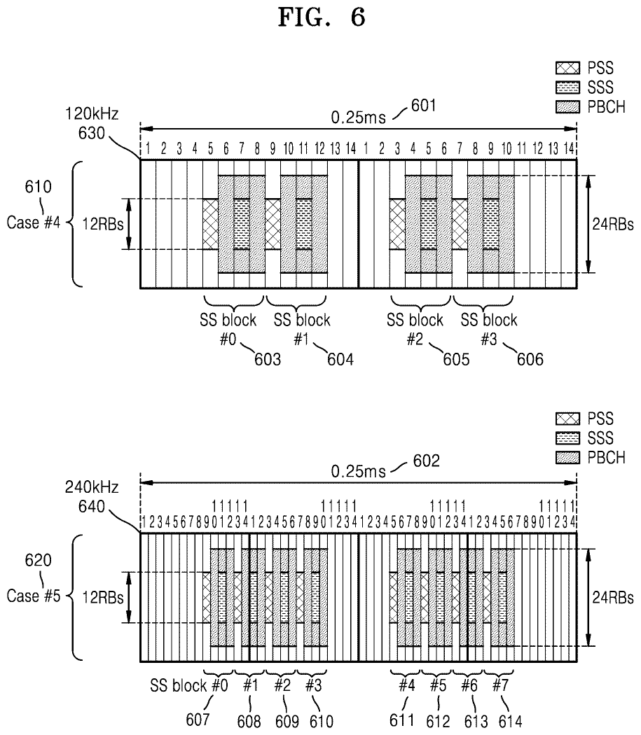

FIG. 6 illustrates examples of transmission cases of an SS block in a frequency band of 6 GHz or more according to an embodiment of the disclosure.

Referring to FIG. 6, in the wireless communication system, SCS of 120 kHz 630 as in an example of a case #4 610 and SCS of 240 kHz 640 as in an example of a case #5 620 may be used for SS block transmission in a frequency band of 6 GHz or more (or RF2, e.g., 24250 MHz to 52600 MHZ).

Maximum four SS blocks may be transmitted within a time of 0.25 ms 601 (or a length of two slots when one slot includes 14 OFDM symbols) in the case #4 610 of the SCS of 120 kHz 630. The example of FIG. 6 illustrates a case in which an SS block #0 603, an SS block #1 604, an SS block #2 605, and an SS block #3 606 are transmitted within a time of 0.25 ms (i.e., two slots). The SS block #0 603 and the SS block #1 604 may be respectively mapped onto four consecutive symbols from a fifth OFDM symbol of a first slot and onto four consecutive symbols from a ninth OFDM symbol of the first slot, and the SS block #2 605 and the SS block #3 606 may be respectively mapped onto four consecutive symbols from a third OFDM symbol of a second slot and onto four consecutive symbols from a seventh OFDM symbol of the second slot.

As described in the above embodiments of the disclosure, different analog beams may be used for the SS block #0 603, the SS block #1 604, the SS block #2 605, and the SS block #3 606. Also, a same analog beam may be used for all four OFDM symbols in which an SS block is transmitted, and the base station may determine which beam to use for OFDM symbols onto which an SS block is not mapped.

Maximum eight SS blocks may be transmitted within a time of 0.25 ms 602 (or a length of four slots when one slot includes 14 OFDM symbols) in the case #5 620 of the SCS of 240 kHz 640. The example of FIG. 6 illustrates a case in which an SS block #0 607, an SS block #1 608, an SS block #2 609, an SS block #3 610, an SS block #4 611, an SS block #5 612, an SS block #6 613, and an SS block #7 614 are transmitted within a time 0.25 ms (i.e., four slots).

The SS block #0 607 and the SS block #1 608 may be respectively mapped onto four consecutive symbols from a ninth OFDM symbol of a first slot and onto four consecutive symbols from a 13th OFDM symbol of the first slot, the SS block #2 609 and the SS block #3 610 may be respectively mapped onto four consecutive symbols from a third OFDM symbol of a second slot and onto four consecutive symbols from a 7th OFDM symbol of the second slot, the SS block #4 611, the SS block #5 612, and the SS block #6 613 may be respectively mapped onto four consecutive symbols from a fifth OFDM symbol of a third slot, onto four consecutive symbols from a ninth OFDM symbol of the third slot, and onto four consecutive symbols from a 13th OFDM symbol of the third slot, and the SS block #7 614 may be mapped onto four consecutive symbols from a third OFDM symbol of a fourth slot.

As described in the above embodiment of the disclosure, different analog beams may be used for the SS block #0 607, the SS block #1 608, the SS block #2 609, the SS block #3 610, the SS block #4 611, the SS block #5 612, the SS block #6 613, and the SS block #7 614. Also, a same analog beam may be used for all four OFDM symbols in which an SS block is transmitted, and the base station may determine which beam to use for OFDM symbols onto which an SS block is not mapped.

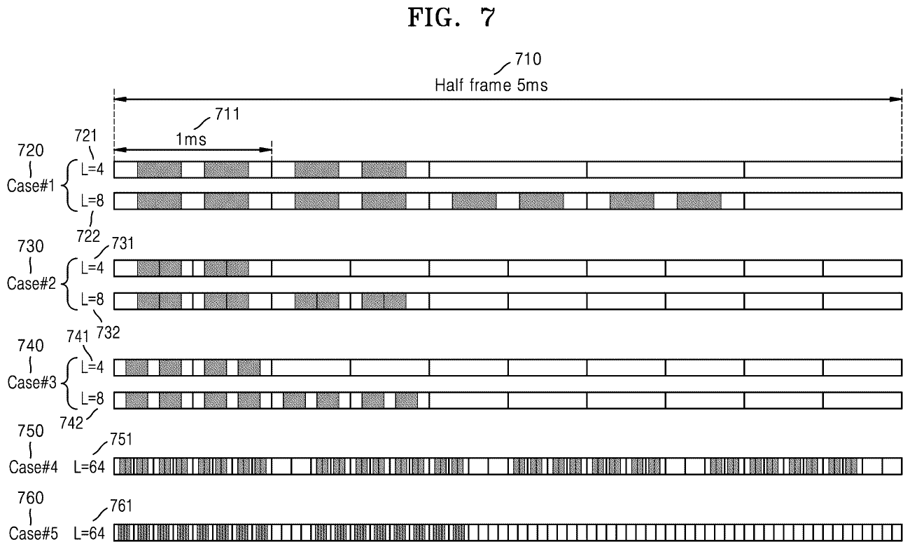

FIG. 7 illustrates examples of transmission cases of an SS block according to SCS within a time of 5 ms in a wireless communication system according to an embodiment of the disclosure.

Referring to FIG. 7, an SS block in a 5G communication system may be periodically transmitted in units of, for example, a time interval of 5 ms 710 (corresponds to 5 subframes 711 or a half frame).

In a frequency band of 3 GHz or less, maximum 4 SS blocks may be transmitted within a time of 5 ms 710. In a frequency band of more than 3 GHz to 6 GHz or less, maximum 8 SS blocks may be transmitted. In a frequency band of more than 6 GHZ, maximum 64 SS blocks may be transmitted. As described above, SCS of 15 kHz and 30 kHz may be used in a frequency band of 6 GHz or less.

In a case #1 720 of FIG. 7, SCS may be 15 kHz and a subframe may include one slot, as in the case #1 501 of FIG. 5. In the case #1 720, an SS block may be mapped onto a first slot and a second slot in the frequency band of 3 GHz or less, and thus, maximum 4 SS blocks 721 may be transmitted, and an SS block may be mapped onto first, second, third, and fourth slots in the frequency band of more than 3 GHz to 6 GHz or less, and thus, maximum 8 SS blocks 722 may be transmitted. In a case #2 730 or a case #3 740 of FIG. 7, SCS may be 30 kHz and a subframe may include two slots, as in the case #2 502 or the case #3 503 of FIG. 5. In the case #2 730 or the case #3 740, an SS block may be mapped from a first slot in the frequency band of 3 GHz or less, and thus, maximum 4 SS blocks 731 or 741 may be transmitted, and an SS block may be mapped from first and third slots in the frequency band of more than 3 GHz to 6 GHz or less, and thus, maximum 8 SS blocks 732 or 742 may be transmitted.

SCSs of 120 kHz and 240 kHz may be used in the frequency band of more than 6 GHz. In a case #4 750 of FIG. 7, SCS may be 120 kHz and a time of 0.25 ms may include two slots, as in the case #4 610 of FIG. 6. In the case #4 750, an SS block may be mapped from first, third, fifth, seventh, 11th, 13th, 15th, 17th, 21st, 23rd, 25th, 27th, 31st, 33rd, 35th, and 37th slots in the frequency band of more than 6 GHZ, and thus, maximum 64 SS blocks 751 may be transmitted. In a case #5 760 of FIG. 7, SCS may be 240 kHz and a time of 0.25 ms may include four slots, as in the case #5 620 of FIG. 6. In the case #5 760, an SS block may be mapped from first, fifth, ninth, 13th, 21st, 25th, 29th, and 33rd slots in the frequency band of more than 6 GHZ, and thus, maximum 64 SS blocks 761 may be transmitted.

A UE may perform decoding on PDCCH and PDSCH, based on system information included in received MIB, and then obtain SIB. The SIB may include at least one of information related to an uplink cell bandwidth, a random access parameter, a paging parameter, or a parameter related to uplink power control.

In general, the UE may establish a radio link with a network through a random access procedure, based on system information and synchronization with the network, which are obtained during a cell search process of a cell. Contention-based random access or contention-free random access may be used. The contention-based random access may be used when the UE performs cell selection and reselection during an initial access stage of the cell, for example, to change from an RRC_IDLE state to an RRC_CONNECTED state. The contention-free random access may be used to reconfigure uplink synchronization when downlink data has reached, when handover is performed, or when location measurement is performed. Table 3 below shows conditions (events) that trigger a random access procedure in a 5G system.

TABLE 3
- Initial access from RRC_IDLE;
- RRC Connection Re-establishment procedure;
- DL or UL data arrival during RRC_CONNECTED when UL
synchronisation status is “non-synchronised”;
- UL data arrival during RRC_CONNECTED when there are no PUCCH
resources for SR available;
- SR failure;
- Request by RRC upon synchronous reconfiguration (e.g. handover);
- RRC Connection Resume procedure from RRC_INACTIVE;
- To establish time alignment for a secondary TAG;
- Request for Other SI;
- Beam failure recovery;
- Consistent UL LBT failure on SpCell.

Hereinafter, a measurement time configuration method for radio resource management (RRM) based on an SS block (or SSB) of a 5G wireless communication system will be described.

A UE receives, through higher layer signaling, a configuration of MeasObjectNR of MeasObjectToAddModList as a configuration for SSB-based intra/inter-frequency measurements and channel state information-reference signal (CSI-RS)-based intra/inter-frequency measurements. For example, MeasObjectNR may be configured as Table 4 below.

TABLE 4

| | |
|---|---|
| MeasObjectNR ::= | SEQUENCE { |

| | |
|---|---|
| ssbFrequency ARFCN-ValueNR | OPTIONAL, |

-- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MTC2 |

OPTIONAL, -- Cond IntraFreqConnected

| | |
|---|---|
| refFreqCSI-RS | ARFCN-ValueNR |

OPTIONAL, -- Cond CSI-RS

| | |
|---|---|
| referenceSignalConfig | ReferenceSignalConfig, |

| | |
|---|---|
| absThreshSS-BlocksConsolidation | ThresholdNR |

OPTIONAL, -- Need R

| | |
|---|---|
| absThreshCSI-RS-Consolidation | ThresholdNR |

OPTIONAL, -- Need R

| | |
|---|---|
| nrofSS-BlocksToAverage | INTEGER (2..maxNrofSS-BlocksToAverage) |

OPTIONAL, -- Need R

| | |
|---|---|
| nrofCSI-RS-ResourcesToAverage | INTEGER (2..maxNrofCSI-RS-ResourcesToAverage) |

OPTIONAL, -- Need R

| | |
|---|---|
| quantityConfigIndex | INTEGER (1..maxNrofQuantityConfig), |
| offsetMO | Q-OffsetRangeList, |

| | |
|---|---|
| cellsToRemoveList | PCI-List |

OPTIONAL, -- Need N

| | |
|---|---|
| cellsToAddModList | CellsToAddModList |

OPTIONAL, -- Need N

| | |
|---|---|
| blackCellsToRemoveList | PCI-RangeIndexList |

OPTIONAL, -- Need N

| | |
|---|---|
| blackCellsToAddModList: | SEQUENCE (SIZE (1..maxNrofPCI-Ranges)) OF PCI-RangeElement |

OPTIONAL, -- Need N

| | |
|---|---|
| whiteCellsToRemoveList | PCI-RangeIndexList |

OPTIONAL, -- Need N

| | |
|---|---|
| whiteCellsToAddModList | SEQUENCE (SIZE (1..maxNrofPCI-Ranges)) OF PCI-RangeElement |

```
OPTIONAL, -- Need N
  ...,
  [[
```

| | |
|---|---|
| freqBandIndicatorNR | FreqBandIndicatorNR |

OPTIONAL, -- Need R

| | |
|---|---|
| measCycleSCell | ENUMERATED {sf160, sf256, sf320, sf512, sf640, sf1024, sf1280} |

```
OPTIONAL, -- Need R
  ]],
  [[
```

| | |
|---|---|
| smtc3list-r16 | SSB-MTC3List-r16 |

OPTIONAL, -- Need R

| | |
|---|---|
| rmtc-Config-r16 | SetupRelease {RMTC-Config-r16} |

OPTIONAL, -- Need M

| | |
|---|---|
| t312-r16 | SetupRelease { T312-r16 } |

OPTIONAL, -- Need M
]]
}

The terms in Table 4 may indicate that following functions are performed. However, the disclosure is not limited thereto.
ssbFrequency: May configure a frequency of a synchronization signal related to MeasObjectNR.
ssbSubcarrierSpacing: Configures SCS of SSB. FR1 may apply only 15 kHz or 30 kHz, and FR2 may apply only 120 kHz or 240 kHz.
smtc1: Indicates an SS/PBCH block measurement timing configuration, may configure a primary measurement timing configuration, and may configure a timing offset and duration for SSB.
smtc2: May configure a secondary measurement timing configuration for SSB related to MeasObjectNR having PCI listed in pci-List.

MeasObjectNR may be configured through another higher layer signaling. For example, an SS/PBCH block measurement timing configuration (SMTC) may be configured for the UE through SIB2 for intra-frequency, inter-frequency, and inter-radio access technology (RAT) cell reselection or through reconfigurationWithSync for an NR PSCell change and an NR PCell change and in addition, the SMTC may be configured in the UE through SCellConfig for NR SCell addition.

The UE may be configured with a first SMTC according to periodictiyAndOffset (provides periodicity and offset) through smtc1 configured through higher layer signaling, for SSB measurement. According to an embodiment of the disclosure, a first subframe of each SMTC occasion may start from an SFN and a subframe of SpCell satisfying conditions of Table 5 below.

TABLE 5

```
SFN mod T = (FLOOR (Offset/10));
if the Periodicity is larger than sf5:
  subframe = Offset mod 10;
else:
  subframe = Offset or (Offset +5);
with T = CEIL(Periodicity/10).
```

When smtc2 is configured, the UE may be configured with an additional SMTC according to periodicity of configured smtc2 and an offset and duration of smtc1, for cells indicated by a value of pci-List of smtc2 in same MeasObjectNR. In addition, the UE may be configured with smtc and measure SSB through smtc3list for smtc2-LP (with long periodicity) and integrated access and backhaul-mobile termination (IAB-MT), for a same frequency (e.g., a frequency for intra frequency cell reselection) or different frequencies (e.g., frequencies for inter frequency cell reselection). According to an embodiment of the disclosure, the UE may not consider an SSB transmitted from a subframe other than an SMTC occasion for SSB-based RRM measurement in configured ssbFrequency.

A base station may use various multi-transmit/receive point (TRP) operating methods according to a serving cell configuration and a physical cell identifier (PCI) configuration. Thereamong, there may be two methods of operating two TRPs when the two TRPs that are physically spaced apart from each other have different PCIs.

### [Operating Method 1]

Two TRPs having different PCIs may be operated through two serving cell configurations.

A base station may include channels and signals transmitted from the different TRPs to different serving cell configurations, through Operating Method 1. In other words, each TRP has an independent serving cell configuration and FrequencyInfoDL that are frequency band values indicated by DownlinkConfigCommon in each serving cell configuration may indicate at least partially overlapping band. Because several TRPs operate based on a plurality of ServCellIndex (e.g., ServCellIndex #1 and ServCellIndex #2), each TRP may use a separate PCI. In other words, the base station may assign one PCI per ServCellIndex.

In this case, when several SSBs are transmitted from TRP 1 and TRP 2, the SSBs have different PCIs (e.g., PCI #1 and PCI #2), and the base station may suitably select a value of ServCellIndex indicated by a cell parameter in QCL-Info to map PCI matching each TRP, and designate SSB transmitted from one of TRP 1 and TRP 2 as source reference RS of QCL configuration information. However, in such a configuration, one serving cell configuration that may be used for carrier aggregation (CA) of the UE is applied to multiple TRPs, and thus, the degree of freedom of CA configuration may be restricted or a signaling load may be increased.

### [Operating Method 2]

Two TRPs having different PCIs may be operated through one serving cell configuration.

A base station may configure channels and signals transmitted from different TRPs through one serving cell configuration, through Operating Method 2. Because a UE operates based on one ServCellIndex (e.g., ServCellIndex #1), it is impossible for the UE to recognize PCI (e.g., PCI #2) assigned to a second TRP. Operating Method 2 may provide more flexibility in CA configuration compared to Operating Method 1 described above, but when several SSBs are transmitted from TRP 1 and TRP 2, the SSBs have different PCIs (e.g., PCI #1 and PCI #2) and it may be impossible for the base station to map PCI (e.g., PCI #2) of the second TRP through ServCellIndex indicated by a cell parameter in QCL-Info. The base station is able to only assign SSB transmitted from TRP 1 to source reference RS of QCL configuration information, and may not be able to assign SSB transmitted from TRP 2.

As described above, in Operating Method 1, multi-TRP operation may be performed for two TRPs having different PCIs through an additional serving cell configuration without an additional standard support, but Operating Method 2 may be performed based on an additional UE capability report and base station configuration information.

### UE Capability Report for Operating Method 2

A UE may report to a base station through UE capability that the base station may configure PCI of a serving cell and another additional PCI, through higher layer signaling. The UE capability may include X1 and X2 that are two independent numbers or X1 and X2 may be reported as independent UE capabilities.
X1 denotes the maximum number of additional PCIs that may be configured in the UE, wherein the PCI may be different from the PCI of the serving cell. Here, a time domain position and periodicity of SSB corresponding to the additional PCI may be the same as those of SSB of the serving cell.
X2 denotes the maximum number of additional PCIs that may be configured in the UE, wherein the PCI may be different from the PCI of the serving cell. Here, a time domain position and periodicity of SSB corresponding to the additional PCI may be different from those of SSB of the serving cell reported through X1.
According to such definitions, PCIs corresponding to the values reported as X1 and X2 are unable to be configured simultaneously.
The values reported as X1 and X2 through the UE capability report may each have a value of one integer from 0 to 7.
The values reported as X1 and X2 may be different in FR1 and FR2.

### Higher Layer Signaling Configuration for Operating Method 2

The UE may receive, from the base station, a configuration of SSB-MTCAdditionalPCI-r17 that is a higher layer signaling, based on the UE capability report, wherein the higher layer signaling may at least include a plurality of additional PCIs having different values from the serving cell, SSB transmit power corresponding to each additional PCI, and ssb-PositionInBurst corresponding to each additional PCI, and the maximum number of additional PCIs that may be configured may be 7.
The UE may assume that the SSB corresponding to the additional PCI having the different value from the serving cell has a central frequency, SCS, and a subframe number offset, which are the same as the SSB of the serving cell.
The UE may assume that a reference RS (e.g., SSB or CSI-RS) corresponding to the PCI of the serving cell is always connected to an activated TCI state, and assume that, when there are one or a plurality of additionally configured PCIs having different values from the serving cell, only one PCI is connected to the activated TCI state.
When the UE is configured with two different coresetPoolIndex, a reference RS corresponding to the PCI of the serving cell is connected to one or a plurality of activated TCI states, and a reference RS corresponding to the additionally configured PCI having a different value from the serving cell is connected to one or a plurality of activated TCI states, the UE may expect that the activated TCI state(s) connected to the PCI of the serving cell is connected to one of two coresetPoolIndex and the activated TCI state(s) connected to the additionally configured PCI having a different value from the serving cell is connected to the remaining one of two coresetPoolIndex.

The UE capability report and the higher layer signaling of the base station for Operating Method 2 described above may configure an additional PCI having a different value from the PCI of the serving cell. When such a configuration does not exist, the SSB corresponding to the additional PCI having a different value from the PCI of the serving cell that is unable to be designated by the source reference RS may be used to designate the source reference RS of the QCL configuration information. Also, unlike SSB that may be configured to be used for RRM, mobility, or handover, based on configuration information about SSB that may be configured in smtc1 and smtc2 that are the higher layer signaling, the SSB corresponding to the additional PCI having a different value from the PCI of the serving cell may be used to function as a QCL source RS for supporting multi-TRP operations having different PCIs.

Next, DMRS that is one of reference signals in a 5G system will be described on detail.

The DMRS may include several DMRS ports, wherein the ports maintain orthogonality by using code division multiplexing (CDM) or frequency division multiplexing (FDM) so as not to interfere with each other. However, the term “DMRS” may be expressed in different terms depending on a user's intention and a purpose of a reference signal. The term “DMRS” is merely illustrative of specific examples to easily facilitate description and understanding of the disclosure, and are not intended to limit the scope of the disclosure. That is, it will be obvious to one of ordinary skill in the art to which the disclosure belongs that the disclosure is applicable to any reference signal, based on the technical idea of the disclosure.

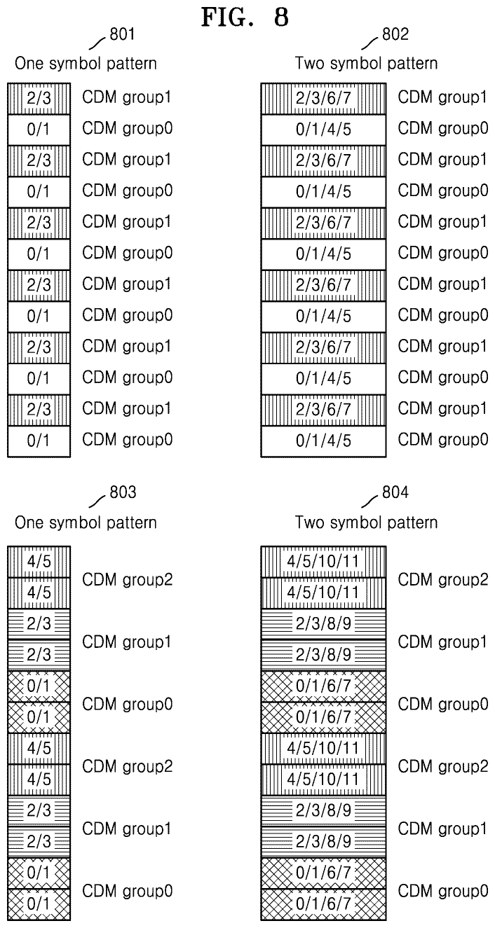

FIG. 8 illustrates examples for describing DMRS patterns (type 1 and type 2) used for a communication between a base station and a UE in a wireless communication system according to an embodiment of the disclosure.

In a 5G system, two DMRS patterns may be supported. FIG. 8 illustrates two DMRS patterns.

Referring to FIG. 8, a DMRS type 1 801 and 802 may specifically include a one symbol pattern 801 and a two symbol pattern 802. The DMRS type 1 801 and 802 are DMRS patterns of a comb 2 structure and may include two CDM groups, wherein FDM may be applied to different CDM groups.

Two DMRS ports may be distinguished for a same CDM group as frequency CDM is applied to the one symbol pattern 801 (e.g., included in the DMRS type 1), and thus, total four orthogonal DMRS ports may be configured. The one symbol pattern 801 may include a DMRS port ID mapped onto each CDM group (e.g., a DMRS port ID for a downlink may be indicated by a number+1000). Four DMRS ports may be distinguished for a same CDM group as time/frequency CDM is applied to the two symbol pattern 802 (e.g., included in the DMRS type 1), and thus, total eight orthogonal DMRS ports may be configured. The two symbol pattern 802 may include a DMRS port ID mapped onto each CDM group (e.g., a DMRS port ID for a downlink may be indicated by a number+1000).

FIG. 8 illustrates an example of a DMRS type 2 803 and 804. The DMRS type 2 803 and 804 is a DMRS pattern having a structure in which frequency domain orthogonal cover codes (FD-OCC) are applied to a frequency-adjacent subcarrier, and may include three CDM groups, wherein FDM may be applied to different CDM groups.

Two DMRS ports may be distinguished for a same CDM group as frequency CDM is applied to one symbol pattern 803, and thus, total six orthogonal DMRS ports may be configured. The one symbol pattern 803 may include a DMRS port ID mapped onto each CDM group (e.g., a DMRS port ID for a downlink may be indicated by a number+1000). Four DMRS ports may be distinguished for a same CDM group as time/frequency CDM is applied to two symbol pattern 804, and thus, total 12 orthogonal DMRS ports may be configured. The two symbol pattern 804 may include a DMRS port ID mapped onto each CDM group (e.g., a DMRS port ID for a downlink may be indicated by a number+1000).

As described above, in an NR system, two different DMRS patterns (e.g., the DMRS type 1 801 and 802 or the DMRS type 2 803 and 804) may be configured. Also, the DMRS patterns may be configured whether each DMRS pattern is the one symbol pattern 801 or 803 or the adjacent two symbol pattern 802 or 804. Also, in the NR system, not only a DMRS port number is scheduled, but also the number of CDM groups scheduled for PDSCH rate matching may be configured through signaling. In addition, for cyclic prefix-based orthogonal frequency division multiplexing (CP-OFDM), the two DMRS patterns described above may both be supported in DL and UL, and for discrete Fourier transform spread OFDM (DFT-S-OFDM), only the DMRS type 1 801 and 802 among the DMRS patterns described above may be supported in UL.

Also, an additional DMRS may be supported to be configurable. A front-loaded DMRS refers to a first DMRS transmitted/received on the frontmost symbol in a time domain, and an additional DMRS refers to a DMRS transmitted/received on a symbol behind the front-loaded DMRS in the time domain. In the NR system, the number of additional DMRS may be set from 0 to 3. When the additional DMRS is configured, a same pattern as the front-loaded DMRS may be assumed. When the additional DMRS is additionally configured, it may be assumed that same DMRS information as the front-loaded DMRS is configured for the additional DMRS. For example, when at least one of information about whether a DMRS pattern type is type 1 or type 2, information about whether a DMRS pattern is a one symbol pattern or an adjacent two symbol pattern, or information about the number of DMRS ports and used CDM groups is indicated for the front-loaded DMRS, the same DMRS information as the front-loaded DMRS may be configured for the additional DMRS in a case where the additional DMRS is additionally configured.

The downlink DMRS configuration described above may be configured through RRC signaling as in Table 6 below, according to an embodiment of the disclosure.

TABLE 6

| DMRS-DownlinkConfig ::= | SEQUENCE { | |
|---|---|---|
| dmrs-Type | ENUMERATED {type2} | OPTIONAL, -- Need S |
| dmrs-AdditionalPosition | ENUMERATED {pos0, pos1, pos3} | OPTIONAL, -- Need S |
| maxLength | ENUMERATED {len2} | OPTIONAL, -- Need S |
| scramblingID0 | INTEGER (0..65535) | OPTIONAL, -- Need S |
| scramblingID1 | INTEGER (0..65535) | OPTIONAL, -- Need S |
| phaseTrackingRS | SetupRelease {PTRS-DownlinkConfig} | OPTIONAL, -- Need M |

...
}

Here, a DMRS type may be configured through dmrs-Type, additional DMRS OFDM symbols may be configured through dmrs-AdditionalPosition, and a one symbol pattern or a two symbol pattern may be configured through maxLength. A scrambling ID may be configured through scramblingID0 and scramblingID1, and a phase tracking reference signal (PTRS) may be configured through phase TrackingRS.

Also, the uplink DMRS configuration described above may be configured through RRC signaling as in Table 7 below.

TABLE 7

| DMRS-UplinkConfig ::= | SEQUENCE { | |
|---|---|---|
| dmrs-Type | ENUMERATED {type2} OPTIONAL, -- Need S | |
| dmrs-AdditionalPosition | ENUMERATED {pos0, pos1, pos3} | OPTIONAL, -- Need R |
| phaseTrackingRS | SetupRelease { PTRS-UplinkConfig } | OPTIONAL, -- Need M |
| maxLength | ENUMERATED {len2} | OPTIONAL, -- Need S |
| transformPrecodingDisabled | SEQUENCE { | |
| scramblingID0 | INTEGER (0..65535) | OPTIONAL, -- Need S |
| scramblingID1 | INTEGER (0..65535) | OPTIONAL, -- Need S |

...

| } | | OPTIONAL, -- Need R |
|---|---|---|
| transformPrecodingEnabled | SEQUENCE { | |
| nPUSCH-Identity | INTEGER (0..1007) | OPTIONAL, -- Need S |
| sequenceGroupHopping | ENUMERATED {disabled} | OPTIONAL, -- Need S |
| sequenceHopping | ENUMERATED {enabled} | OPTIONAL, -- Need S |

...

| | |
|---|---|
| } | OPTIONAL, -- Need R |

...
}

Here, a DMRS type may be configured through dmrs-Type, additional DMRS OFDM symbols may be configured through dmrs-AdditionalPosition, PTRS may be configured through phaseTrackingRS, and a one symbol pattern or a two symbol pattern may be configured through maxLength. Scrambling ID0 may be configured through scramblingID0 and scramblingID1, a cell ID for DFT-s-OFDM may be configured through nPUSCH-Identity, sequence group hopping may be disabled through sequenceGroupHopping, and sequence hopping may be enabled through sequenceHopping.

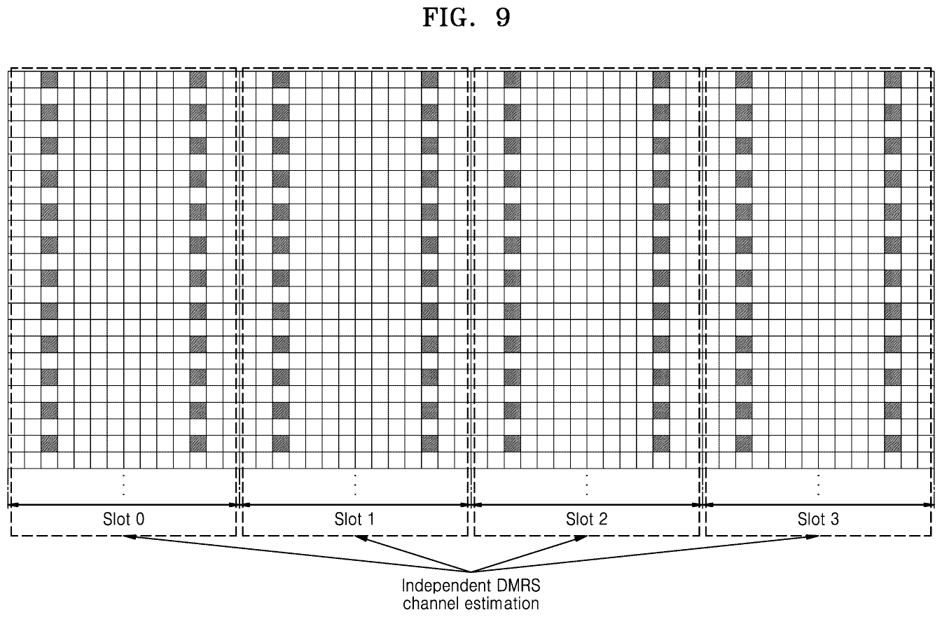

FIG. 9 illustrates an example of channel estimation using a DMRS received on one physical uplink shared channel (PUSCH) in a time band of a wireless communication system according to an embodiment of the disclosure.

Referring to FIG. 9, when performing channel estimation for data decoding by using DMRS, the channel estimation may be performed within a precoding resource block group (PRG) that is a bundling unit, by using physical resource block (PRB) bundling linked to a system band, in a frequency band. Also, in a time unit, the channel estimation may be performed under the assumption that precoding is the same for DMRS received from only one PUSCH.

Hereinafter, a time domain resource allocation (TDRA) method for a data channel in a 5G communication system will be described. A base station may configure, to a UE, a TDRA information table for a PDSCH and a PUSCH, through higher layer signaling (for example, RRC signaling).

For the PDSCH, the base station may configure a table consisting of up to maxNrofDL-Allocations=17 entries, and for the PUSCH, the base station may configure a table consisting of up to maxNrofUL-Allocations=17 entries. TDRA may include, for example, at least one of a PDCCH-to-PDSCH slot timing (corresponds to a time interval in a slot unit between a time point when the PDCCH is received and a time point when the PDSCH scheduled by the received PDCCH is transmitted, indicated by K0), or a PDCCH-to-PUSCH slot timing (corresponds to a time interval in a slot unit between a time point when the PDCCH is received and a time point when the PUSCH scheduled by the received PDCCH is transmitted, indicated by K2), information about a location and length of a starting symbol where the PDSCH or PUSCH is scheduled within a slot, or a mapping type of the PDCH or PUSCH.

According to an embodiment of the disclosure, the TDRA information for the PDSCH may be configured to the UE through RRC signaling as shown in Table 8 below.

TABLE 8
PDSCH-TimeDomainResourceAllocationList information element

PDSCH-TimeDomainResourceAllocationList ::= SEQUENCE (SIZE(1..maxNrofDL-Allocations)) OF PDSCH-
TimeDomainResourceAllocation
PDSCH-TimeDomainResourceAllocation ::= SEQUENCE {

| | |
|---|---|
| k0 | INTEGER(0..32) OPTIONAL, -- Need S |
| mappingType | ENUMERATED {typeA, typeB}, |
| startSymbolAndLength | INTEGER (0..127) |
| repetitionNumber | ENUMERATED {n2, n3, n4, n5, n6, n7, n8, n16} OPTIONAL, -- Cond |

Formats1-0and1-1
}

Here, k0 may indicate the PDCCH-to-PDSCH timing (i.e., a slot offset between downlink control information (DCI) and PDSCH scheduled therefor) in a slot unit, mappingType may indicate a PDSCH mapping type, startSymbolAndLength may indicate a starting symbol and length of PDSCH, and repetitionNumber may indicate the number of PDSCH transmission occasions according to a slot-based repetition method. This is only an example, and pieces of information described above may be indicated in a time unit instead of a slot unit. For example, k0 may be in a symbol unit.

According to an embodiment of the disclosure, the TDRA information for the PUSCH may be configured to the UE through RRC signaling as shown in Table 9 below.

TABLE 9
PUSCH-TimeDomainResourceAllocation information element

PUSCH-TimeDomainResourceAllocationList ::= SEQUENCE (SIZE(1..maxNrofUL-Allocations)) OF PUSCH-
TimeDomainResourceAllocation

| PUSCH-TimeDomainResourceAllocation ::= | SEQUENCE { | |
|---|---|---|
| k2 | INTEGER(0..32) | OPTIONAL, -- Need S |

| | |
|---|---|
| mappingType | ENUMERATED {typeA, typeB}, |
| startSymbolAndLength | INTEGER (0..127) |

}
PUSCH-Allocation-r16 ::= SEQUENCE {

| | | |
|---|---|---|
| mapping Type-r16 | ENUMERATED {typeA, typeB} | OPTIONAL, -- Cond NotFormat01- |

02-Or-TypeA

| | | |
|---|---|---|
| startSymbolAndLength-r16 | INTEGER (0..127) | OPTIONAL, -- Cond NotFormat01-02-Or-TypeA |
| startSymbol-r16 | INTEGER (0..13) | OPTIONAL, -- Cond RepTypeB |
| length-r16 | INTEGER (1..14) | OPTIONAL, -- Cond RepTypeB |

| | |
|---|---|
| numberOfRepetitions-r16 | ENUMERATED {n1, n2, n3, n4, n7, n8, n12, n16} OPTIONAL, -- Cond |

Format01-02
...
}

Here, k2 may indicate the PDCCH-to-PUSCH timing (i.e., a slot offset between DCI and PUSCH scheduled therefor in a slot unit, mappingType may indicate a PUSCH mapping type, startSymbolAndLength or StartSymbol and length may indicate a starting symbol and length of PUSCH, and numberOfRepetitions may indicate the number of repetitions applied to PUSCH transmission. This is only an example, and pieces of information described above may be indicated in a time unit instead of a slot unit. For example, k2 may be in a symbol unit.

The base station may indicate, to the UE, at least one of entries of the table about the TDRA information through L1 signaling (e.g., DCI) (e.g., may be indicated through “TDRA” field in the DCI). The UE may obtain the TDRA information for the PDSCH or PUSCH, based on the DCI received from the base station.

Hereinafter, transmission of PUSCH in a 5G system will be described in detail. PUSCH transmission may be dynamically scheduled by UL grant in DCI (e.g., referred to as dynamic grant (DG)-PUSCH) or scheduled by configured grant Type 1 or configured grant Type 2 (e.g., referred to as configured grant (CG)-PUSCH). Dynamic scheduling for the PUSCH transmission may be indicated by, e.g., DCI format 0_0 or 0_1.

The configured grant Type 1 PUSCH transmission may be semi-statically configured through reception of configuredGrantConfig including rrc-ConfiguredUplinkGrant of Table 10 through higher layer signaling, without receiving the UL grant in the DCI. The configured grant Type 2 PUSCH transmission may be semi-persistently scheduled by the UL grant in the DCI after reception of configuredGrantConfig not including rrc-ConfiguredUplinkGrant of Table 10, through higher layer signaling.

According to an embodiment of the disclosure, when the PUSCH transmission is configured by configured grant, parameters applied to the PUSCH transmission may be configured through configuredGrantConfig that is higher layer signaling of Table 10, excluding specific parameters (e.g., dataScramblingIdentityPUSCH, txConfig, codebookSubset, maxRank, or scaling of UCI-OnPUSCH) provided through pusch-Config of Table 11, which is higher layer signaling. For example, when the UE is provided with transformPrecoder in the configuredGrantConfig that is higher layer signaling of Table 10, the UE may apply tp-pi2BPSK in the pusch-Config of Table 11 with respect to the PUSCH transmission operating by the configured grant.

TABLE 10
ConfiguredGrantConfig

| ConfiguredGrantConfig ::= | SEQUENCE { | |
|---|---|---|
| frequencyHopping | ENUMERATED {intraSlot, interSlot} | OPTIONAL, -- Need S, |
| cg-DMRS-Configuration | DMRS-UplinkConfig, | |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| uci-OnPUSCH | SetupRelease { CG-UCI-OnPUSCH } | OPTIONAL, -- Need M |

| | |
|---|---|
| resourceAllocation | ENUMERATED { resourceAllocationType0, resourceAllocationType1, |

dynamicSwitch },

| rbg-Size | ENUMERATED {config2) | OPTIONAL, -- Need S |
|---|---|---|
| powerControlLoopToUse | ENUMERATED {n0, n1}, | |
| p0-PUSCH-Alpha | P0-PUSCH-AlphaSetId, | |
| transformPrecoder | ENUMERATED {enabled, disabled} | OPTIONAL, -- Need S |
| nrofHARQ-Processes | INTEGER(1..17), | |
| repK | ENUMERATED {n1, n2, n4, n8}, | |
| repK-RV | ENUMERATED {s1-0231, s2-0303, s3-0000} | OPTIONAL, -- Need R |

| | |
|---|---|
| periodicity | ENUMERATED { |

```
  sym2, sym7, sym1x14, sym2x14, sym4x14, sym5x14, sym8x14, sym10x14, sym17x14, sym20x14,
  sym32x14, sym40x14, sym64x14, sym80x14, sym128x14, sym170x14, sym256x14, sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym17x12, sym20x12, sym32x12,
  sym40x12, sym64x12, sym80x12, sym128x12, sym170x12, sym256x12, sym320x12, sym512x12, sym640x12,
  sym1280x12, sym2560x12
  },
```

| | | |
|---|---|---|
| configuredGrantTimer | INTEGER (1..64) | OPTIONAL, -- Need R |

| | |
|---|---|
| rrc-ConfiguredUplinkGrant | SEQUENCE { |

| timeDomainOffset | INTEGER (0..5119), | |
|---|---|---|
| timeDomainAllocation | INTEGER (0..16), | |
| frequencyDomainAllocation | BIT STRING (SIZE(18)), | |
| antennaPort | INTEGER (0..31), | |
| dmrs-SeqInitialization | INTEGER (0..1) | OPTIONAL, -- Need R |
| precodingAndNumberOfLayers | INTEGER (0..63), | |
| srs-ResourceIndicator | INTEGER (0..16) | OPTIONAL, -- Need R |

| | |
|---|---|
| mcsAndTBS | INTEGER (0..31), |
| frequencyHoppingOffset | INTEGER (1.. maxNrofPhysicalResourceBlocks-1) OPTIONAL, |

-- Need R

| | |
|---|---|
| pathlossReferenceIndex | INTEGER (0..maxNrofPUSCH-PathlossReferenceRSs-1), |

...

| | |
|---|---|
| } | OPTIONAL, -- Need R |

...
}

Next, a PUSCH transmission method will be described. A DMRS antenna port for PUSCH transmission may be the same as an antenna port for SRS transmission. The PUSCH transmission may follow a codebook-based transmission method or a non-codebook-based transmission method, depending on whether a value of the pusch-Config of Table 11, which is higher layer signaling, is codebook or nonCodebook. As described above, the PUSCH transmission may be dynamically scheduled through the DCI format 0_0 or 0_1, and may be configured semi-statically by the configured grant.

When the UE is scheduled for the PUSCH transmission through the DCI format 0_0, the UE may perform a beam configuration for the PUSCH transmission by using pucch-spatialRelationInfoID corresponding to a UE-specific (dedicated) PUSCCH resource having a lowest ID in an UL bandwidth part (BWP) activated in a serving cell. According to an embodiment of the disclosure, the PUSCH transmission may be performed based on a single antenna port. The UE may not expect the scheduling for the PUSCH transmission through the DCI format 0_0, in a BWP in which a PUCCH resource including pucch-spatialRelationInfo is not configured. When the UE is not configured with txConfig in the pusch-Config of Table 11, the UE may not expect scheduling through the DCI format 0_1.

TABLE 11
PUSCH-Config

| PUSCH-Config ::= | SEQUENCE { | |
|---|---|---|
| dataScramblingIdentityPUSCH | INTEGER (0..1023) | OPTIONAL, -- Need S |

| | | |
|---|---|---|
| txConfig | ENUMERATED {codebook, nonCodebook} | OPTIONAL, -- Need S |

| dmrs-UplinkForPUSCH-MappingTypeA | SetupRelease { DMRS-UplinkConfig } OPTIONAL, -- Need M | |
|---|---|---|
| dmrs-UplinkForPUSCH-MappingTypeB | SetupRelease { DMRS-UplinkConfig } OPTIONAL, -- Need M | |
| pusch-PowerControl | PUSCH-PowerControl | OPTIONAL, -- Need M |
| frequencyHopping | ENUMERATED {intraSlot, interSlot} | OPTIONAL, -- Need S |

| | |
|---|---|
| frequencyHoppingOffsetLists | SEQUENCE (SIZE (1..4)) OF INTEGER (1.. |

| | |
|---|---|
| maxNrofPhysicalResourceBlocks-1) | OPTIONAL, -- Need M |
| resourceAllocation | ENUMERATED { resourceAllocationType0, resourceAllocation Type1, |

dynamicSwitch},

| | |
|---|---|
| pusch-TimeDomainAllocationList | SetupRelease { PUSCH-TimeDomainResourceAllocationList } |

OPTIONAL, -- Need M

| | | |
|---|---|---|
| pusch-AggregationFactor | ENUMERATED { n2, n4, n8 } | OPTIONAL, -- Need S |
| mcs-Table | ENUMERATED {qam256, qam64LowSE} | OPTIONAL, -- Need S |
| mcs-TableTransformPrecoder | ENUMERATED {qam256, qam64LowSE} | OPTIONAL, -- Need S |
| transformPrecoder | ENUMERATED {enabled, disabled} | OPTIONAL, -- Need S |

```
  codebookSubset ENUMERATED {fullyAndPartialAndNonCoherent, partialAndNonCoherent,nonCoherent}
    OPTIONAL, -- Cond codebookBased
```

| | | |
|---|---|---|
| maxRank | INTEGER (1..4) | OPTIONAL, -- Cond codebookBased |

| | | |
|---|---|---|
| rbg-Size | ENUMERATED { config2} | OPTIONAL, -- Need S |
| uci-OnPUSCH | SetupRelease { UCI-OnPUSCH} | OPTIONAL, -- Need M |
| tp-pi2BPSK | ENUMERATED {enabled} | OPTIONAL, -- Need S |

...
}

Next, codebook-based PUSCH transmission will be described. The codebook-based PUSCH transmission may be dynamically scheduled through the DCI format 0_0 or 0_1, and may semi-statically operate by the configured grant. When the codebook-based PUSCH transmission is dynamically scheduled by the DCI format 0_1 or semi-statically configured by the configured grant, the UE may determine a precoder for the PUSCH transmission, based on an SRS resource indicator (SRI), a transmission precoding matrix indicator (TPMI), and a transmission rank (the number of PUSCH transmission layers).

According to an embodiment of the disclosure, the SRI may be provided through a field SRS resource indicator in the DCI or through srs-ResourceIndicator that is higher layer signaling. The UE may be configured with at least one SRS resource, and may be configured up to two SRS resources, during the codebook-based PUSCH transmission. When the UE is provided with the SRI through the DCI, an SRS resource indicated by the SRI may denote an SRS resource corresponding to the SRI, from among SRS resources transmitted before a PDCCH including the SRI. Also, the TPMI and transmission rank may be provided through field precoding information and number of layers in the DCI or may be configured through precodingAndNumberOfLayers that is higher layer signaling. The TPMI may be used to indicate a precoder applied to the PUSCH transmission.

The precoder to be used for the PUSCH transmission may be selected from an uplink codebook having the number of antenna ports equal to a value of nrofSRS-Ports in SRS-Config that is higher layer signaling. In the codebook-based PUSCH transmission, the UE may determine a codebook subset, based on the TPMI and the codebookSubset in the pusch-Config that is higher layer signaling. According to an embodiment of the disclosure, the codebookSubset in the pusch-Config that is higher layer signaling may be configured to be one of fullyAndPartialAndNonCoherent, partialAndNonCoherent, and nonCoherent, based on UE capability reported by the UE to the base station.

When the UE reported partialAndNonCoherent as the UE capability, the UE may not expect a value of codebookSubset that is higher layer signaling to be configured to fullyAndPartialAndNonCoherent. Also, when the UE reported nonCoherent as the UE capability, the UE may not expect the value of codebookSubset that is higher layer signaling to be configured to fullyAndPartialAndNonCoherent or partialAndNonCoherent. When nrofSRS-Ports in SRS-ResourceSet that is higher layer signaling indicates two SRS antenna ports, the UE may not expect the value of codebookSubset that is higher layer signaling to be configured to partialAndNonCoherent.

The UE may be configured with one SRS resource set in which a value of usage in SRS-ResourceSet that is higher layer signaling is configured to codebook, and one SRS resource in the SRS resource set may be indicated via SRI. When several SRS resources are configured in the SRS resource set in which the value of usage in SRS-ResourceSet that is higher layer signaling is configured to codebook, the UE may expect a value of nrofSRS-Ports in SRS-Resource that is higher layer signaling to be the same for all SRS resources.

The UE transmits, to the base station, one or a plurality of SRS resources included in the SRS resource set in which the value of usage is configured to codebook according to higher layer signaling, and the base station may select one of the SRS resources transmitted by the UE and instruct the UE to perform the PUSCH transmission, by using transmission beam information of the selected SRS resource. According to an embodiment of the disclosure, in the codebook-based PUSCH transmission, SRI may be used as information for selecting an index of one SRS resource, and included in the DCI. In addition, the base station may include, to the DCI, information indicating the TPMI and rank to be used by the UE for the PUSCH transmission and transmit the same. The UE may perform the PUSCH transmission by applying the precoder indicated by the TPMI and rank indicated based on a transmission beam of the SRS resource, by using the SRS resource indicated by the SRI.

Next, non-codebook-based PUSCH transmission will be described. The non-codebook-based PUSCH transmission may be dynamically scheduled through the DCI format 0_0 or 0_1, or may semi-statically operate by the configured grant. When at least one SRS resource is configured in the SRS resource set in which a value of usage in SRS-ResourceSet that is higher layer signaling is configured to nonCodebook, the UE may receive scheduling of the non-codebook-based PUSCH transmission through the DCI format 0_1.

Regarding the SRS resource set in which the value of usage in SRS-ResourceSet that is higher layer signaling is configured to nonCodebook, the UE may receive configuration of one non-zero power (NZP) CSI-RS resource associated with the SRS resource set. The UE may perform calculation regarding a precoder for SRS transmission through measurement on the NZP CSI-RS resource configured in association with to the SRS resource set. When a difference between a last reception symbol of an aperiodic NZP CSI-RS resource associated with the SRS resource set and a first symbol of aperiodic SRS transmission in the UE is less than specific symbols (e.g., 42 symbols), the UE may not expect information regarding the precoder for SRS transmission to be updated.

When a value of resourceType in SRS-ResourceSet that is higher layer signaling is configured as “aperiodic.” NZP CSI-RS associated with SRS-ResourceSet may be indicated through an SRS request that is a field in a DCI format 0_1 or 1_1. According to an embodiment of the disclosure, when the NZP CSI-RS resource associated with SRS-ResourceSet is an aperiodic NZP CSI resource and a value of the field SRS request in the DCI format 0_1 or 1_1 is not “00.” NZP CSI-RS associated with SRS-ResourceSet may be present. The DCI may not indicate cross carrier or cross BWP scheduling. When the value of SRS request indicates the presence of NZP CSI-RS, the NZP CSI-RS may be located on a slot on which PDCCH including an SRS request field is transmitted. TCI states configured in a scheduled subcarrier may not be configured to be QCL-TypeD.

When the SRS resource set is configured periodically or semi-persistently, the NZP CSI-RS associated with the SRS resource set may be indicated through associatedCSI-RS in SRS-ResourceSet that is higher layer signaling. Regarding the non-codebook-based transmission, the UE may not expect spatialRelationInfo that is higher layer signaling for the SRS resource and associatedCSI-RS in SRS-ResourceSet that is higher layer signaling to be configured together.

When a plurality of SRS resources is configured, the UE may determine the precoder and a transmission rank to be applied to the PUSCH transmission, based on SRI indicated by the base station. According to an embodiment, the SRI may be indicated through a field SRS resource indicator in the DCI or configured through srs-ResourceIndicator that is higher layer signaling. Like the codebook-based PUSCH transmission, when the UE receives the SRI through the DCI, the SRS resource indicated by the SRI may denote an SRS resource corresponding to the SRI from among SRS resources transmitted prior to the PDCCH including the SRI. The UE may use one or a plurality of SRS resources for SRS transmission, and the maximum number of SRS resources capable of being simultaneously transmitted from a same symbol in one SRS resource set may be determined by UE capability reported by the UE to the base station. The SRS resources simultaneously transmitted by the UE may occupy a same RB. The UE may configure one SRS port for each SRS resource. Only one SRS resource set, in which the value of usage in SRS-ResourceSet that is higher layer signaling is configured to be nonCodebook, may be configured, and up to 4 SRS resources for the non-codebook-based PUSCH transmission may be configured.

The base station may transmit, to the UE, one NZP CSI-RS associated with an SRS resource set, and the UE may calculate a precoder to be used to transmit one or a plurality of SRS resources in the SRS resource set, based on a result measured when receiving the NZP CSI-RS. The UE applies the calculated precoder when transmitting, to the base station, one or plurality of SRS resources in the SRS resource set, in which the usage is configured to be nonCodebook, and the base station may select one or plurality of SRS resources from among the received one or plurality of SRS resources. In the non-codebook-based PUSCH transmission, the SRI may denote an index capable of representing one SRS resource or a combination of a plurality of SRS resources, and the SRI may be included in the DCI. The number of SRS resources indicated by the SRI transmitted by the base station may be the number of transmission layers of the PUSCH, and the UE may transmit the PUSCH by applying, to each layer, the precoder applied for the SRS resource transmission.

Hereinafter, a single transport block (TB) transmission method through multiple slots and repetitive transmission of uplink data channel (PUSCH) in a 5G system will be described. The 5G system may support two types of repetitive transmission methods of the uplink data channel (e.g., PUSCH repetitive transmission type A and a PUSCH repetitive transmission type B) and TB processing over multiple slots (TBoMS) for transmitting, on multi-PUSCH, a single TB over a multi-slot. Also, the UE may be configured with one of the PUSCH repetitive transmission type A and B through higher layer signaling. Also, the UE may transmit TBoMS by receiving a configuration of umberOfSlotsTBoMS through a resource allocation table.

### PUSCH Repetitive Transmission Type A

As described above, a starting symbol and length of an uplink data channel may be determined via the TDRA method in one slot, and the base station may indicate the UE of the number of repetitive transmissions through higher layer signaling (for example, RRC signaling) or L1 signaling (for example, DCI). The number N of slots configured as numberOfSlotsTBoMS to determine TBS is 1.
Based on the number of repetitive transmissions indicated by the base station, the UE may repetitively transmit, on consecutive slots, the uplink data channel having a starting symbol and length identical to the starting symbol and length of the uplink data channel configured above. According to an embodiment of the disclosure, in a slot configured by the base station to the UE as downlink or when at least one symbol from among symbols in a slot for uplink data channel repetitive transmission configured to the UE is configured as downlink, the UE may omit uplink data channel transmission in the corresponding slot. For example, the UE may not transmit an uplink data channel within the number of repetitive transmissions of the uplink data channel. On the other hand, the UE that supports Rel-17 uplink data repetitive transmission determines an available slot for a slot in which uplink data repetitive transmission is possible, and the slot that is determined to be the available slot may count the number of transmissions during uplink data channel repetitive transmission. When the uplink data channel repetitive transmission determined as the available slot is omitted, the omitted uplink data channel repetitive transmission may be postponed and then repeatedly transmitted through a transmittable slot. A redundancy version may be applied according to a redundancy version pattern configured for each nth PUSCH transmission occasion by using Table 12 below.

### PUSCH Repetitive Transmission Type B

As described above, the starting symbol and length of the uplink data channel may be determined via the TDRA method in one slot, and the base station may transmit, to the UE, the number of repetitive transmissions numberofrepetitions through higher layer signaling (for example, RRC signaling) or L1 signaling (for example, DCI). According to an embodiment of the disclosure, the number N of slots configured as numberOfSlotsTBoMS to determine TBS is 1.
First, based on the starting symbol and length of the uplink data channel configured above, nominal repetition of the uplink data channel may be determined as below. Here, the nominal repetition may denote a resource of a symbol configured by the base station for PUSCH repetitive transmission, and the UE may determine a resource that may be used as uplink in the configured nominal repetition. In this case, a slot on which nth nominal repetition starts is provided according to

$${K}_{s} + ⌊ \frac{S + n \cdot L}{{N}_{symb}^{slot}} ⌋ ,$$

and a symbol on which the nominal repetition starts from the starting slot may be provided according to mod(S+n·L, N_{symb}^{slot}). A slot on which the nth nominal repetition ends is provided according to

$${K}_{s} + ⌊ \frac{S + ( n + 1 ) \cdot L - 1}{{N}_{symb}^{slot}} ⌋$$

and a symbol on which the nominal repetition ends at the last slot is provided according to mod(S+(n+1)·L−1, N_{symb}^{slot}). Here, n may be 0 to numberofrepetitions-1, S may denote the starting symbol of the configured uplink data channel, and L may denote the symbol length of the configured uplink data channel. Kₛ may denote a slot on which PUSCH transmission starts, and N_{symb}^{slot} may denote the number of symbols per slot.
The UE may determine an invalid symbol for the PUSCH repetitive transmission type B. A symbol configured to be downlink by tdd-UL-DL-ConfigurationCommon or tdd-UL-DL-ConfigurationDedicated may be determined to be the invalid symbol for the PUSCH repetitive transmission type B. In addition, the invalid symbol may be configured based on a higher layer parameter (for example, InvalidSymbolPattern). For example, the invalid symbol may be configured by providing, through the higher layer parameter (for example, InvalidSymbolPattern), a symbol level bitmap over one slot or two slots. According to an embodiment of the disclosure, 1 indicated in the bitmap may indicate the invalid symbol. In addition, a cycle and pattern of the bitmap may be configured through a higher layer parameter (for example, periodicityAndPattern). When the higher layer parameter (for example, InvalidSymbolPattern) is configured and an InvalidSymbolPatternIndicator-ForDCIFormat0_1 or InvalidSymbolPatternIndicator-ForDCIFormat0_2 parameter indicates 1, the UE may apply an invalid symbol pattern, and when the InvalidSymbolPatternIndicator-ForDCIFormat0_1 or InvalidSymbolPatternIndicator-ForDCIFormat0_2 parameter indicates 0, the UE may not apply the invalid symbol pattern. Alternatively, when the higher layer parameter (for example, InvalidSymbolPattern) is configured and the InvalidSymbolPatternIndicator-ForDCIFormat0_1 or InvalidSymbolPatternIndicator-ForDCIFormat0_2 parameter is not configured, the UE may apply the invalid symbol pattern.
After the invalid symbol is determined in each nominal repetition, the UE may consider symbols obtained by excluding the determined invalid symbol as a valid symbol. When each nominal repetition includes at least one valid symbol, the nominal repetition may include one or more actual repetitions. Here, actual repetition may denote a symbol that is actually used for PUSCH repetitive transmission from among symbols configured for the configured nominal repetition, and may include a set of consecutive valid symbols that may be used for PUSCH repetitive transmission type B in one slot. The UE may omit actual repetition transmission when the actual repetition having one symbol is configured to be valid, except for a case in which a symbol length L of the configured uplink data channel is 1. A redundancy version may be applied according to a redundancy version pattern configured for each nth actual repetition by using Table 12 below.
   TB Processing over Multiple Slots (TBoMS)
As described above, a starting symbol and length of an uplink data channel may be determined via the TDRA method in one slot, and the base station may transmit, to the UE, the number of repetitive transmissions through higher layer signaling (for example, RRC signaling) or L1 signaling (for example, DCI). According to an embodiment of the disclosure, TBS may be determined by using a value of N of 1 or more, which is the number of slots configured by numberOfSlotsTBoMS.
The UE may transmit, based on the number of repetitive transmissions and the number of slots for determining the TBS received from the base station, an uplink data channel having a same starting symbol and length as the uplink data channel configured above, on consecutive slots. According to an embodiment of the disclosure, in a slot configured by the base station to the UE as downlink or when at least one symbol from among symbols in a slot for uplink data channel repetitive transmission configured to the UE is configured as downlink, the UE may omit uplink data channel transmission in the corresponding slot. For example, the uplink data channel transmission omitted in the corresponding slot may be included in the number of repetitive transmissions of the uplink data channel, but may not be transmitted.

On the other hand, the UE that supports Rel-17 uplink data repetitive transmission determines an available slot for a slot in which uplink data repetitive transmission is possible, and the slot that is determined to be the available slot may count the number of transmissions during uplink data channel repetitive transmission. When the uplink data channel repetitive transmission determined as the available slot is omitted, the omitted uplink data channel repetitive transmission may be postponed and then repeatedly transmitted through a transmittable slot. According to an embodiment of the disclosure, a redundancy version may be applied according to a redundancy version pattern configured for each nth PUSCH transmission occasion by using Table 12 below.

TABLE 12

| rv_{id} indicated by | rv_{id} to be applied to n^{th} transmission occasion (repetition Type A) or TB | | | |
|---|---|---|---|---|
| the DCI | processing over multiple slots) or n^{th} actual repetition (repetition Type B) | | | |
| scheduling the | ((n − (n mod | ((n − (n mod | ((n − (n mod | ((n − (n mod |
| PUSCH | N))/N) mod 4 = 0 | N))/N) mod 4 = 0 | N))/N) mod 4 = 0 | N))/N) mod 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, a method of determining an uplink available slot for single or multi-PUSCH transmission in a 5G system will be described.

According to an embodiment of the disclosure, when the UE is configured with enable for AvailableSlotCounting, the UE may determine an available slot based on tdd-UL-DL-ConfigurationCommon, tdd-UL-DL-ConfigurationDedicated, ssb-PositionsInBurst, and TDRA information field value, for PUSCH repetitive transmission type A and TBoMS PUSCH transmission. In other words, when at least one symbol configured by TDRA for PUSCH in one slot for PUSCH transmission overlaps at least one symbol for a purpose other than uplink transmission, the corresponding slot may be determined as an unavailable slot.

Hereinafter, a method of reducing SSB density through dynamic signaling for base station energy reduction in a 5G system will be described.

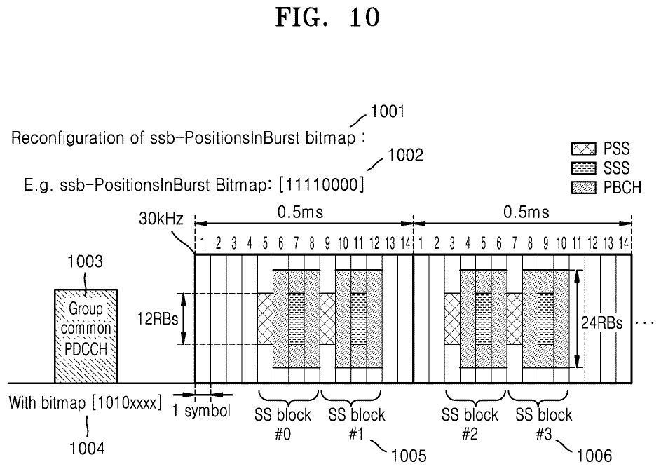

FIG. 10 illustrates an example of a method for reconfiguring SSB transmission through dynamic signaling of a wireless communication system according to an embodiment of the disclosure.

Referring to FIG. 10, the UE may receive a configuration of ssb-PositionsInBurst=“11110000” (1002) from the base station through higher layer signaling (SIB1 or ServingCellConfigCommon) and maximum two SS blocks may be transmitted within a time of 0.5 ms (or corresponds to a length of one slot when one slot includes 14 OFDM symbols) in SCS of 30 kHz, and accordingly, the UE may receive four SS blocks within a time of 1 ms (or corresponds to a length of two slots when one slot includes 14 OFDM symbols). Here, to reduce density of SSB transmission for energy reduction, the base station may reconfigure SSB transmission configuration information by a broadcasting bitmap “1010xxxx” 1004 through group/cell common DCI 1003 having a network energy saving-radio network temporary identifier (nwes-RNTI) (or es-RNTI). In this case, transmissions of SS block #1 1005 and SS block #3 1006 may be canceled based on the bitmap 1004 configured through the group/cell common DCI 1003. FIG. 10 illustrates a method 1001 of reconfiguring SSB transmission through bitmap-based group/cell common DCI.

Also, the base station may reconfigure ssb-periodicity configured through higher layer signaling, through the group/cell common DCI 1003. In addition, the base station may additionally configure timer information for indicating an application time for the group/cell common DCI 1003, so as to transmit SSB through SSB transmission information reconfigured by the group/cell common DCI 1003 during a set timer. When the timer stops, the base station may operate according to the SSB transmission information configured by existing higher layer signaling. A configuration may be changed from a normal mode to an energy saving mode through the timer, and accordingly, SSB configuration information may be reconfigured. According to another method, the base station may configure the UE with an application time and period of SSB configuration information reconfigured through the group/cell common DCI 1003, by using offset and duration information. Here, the UE may not monitor the SSB for the duration from a time when an offset is applied at a moment the group/cell common DCI 1003 is received.

Hereinafter, a BWP or bandwidth (BW) adaptation method through dynamic signaling for base station energy reduction in a 5G system will be described.

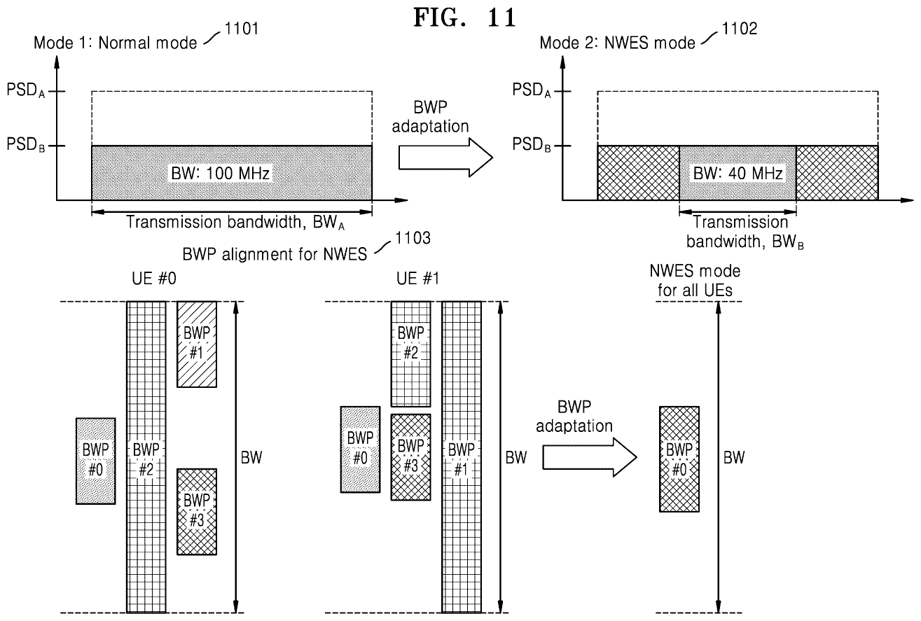

FIG. 11 illustrates an example of a method for reconfiguring a BWP and a BW through dynamic signaling of a wireless communication system, according to an embodiment of the disclosure.

Referring to FIG. 11, the UE may operate according to activated BWP or BW through higher layer signaling or L1 signaling from the base station (1101). For example, the UE may operate through full BW of 100 MHz with fixed power PSD_{B}. The base station may adjust the BW and BWP so that the UE activates a narrower BW of 40 MHz with same power PSD_{B} for energy saving (1102). At this time, the base station may adjust the BW or BWP for energy saving through L1 signaling. For example, the adjusting of the BW or BWP for energy saving may be performed through group common DCI and cell-specific DCI, and may be configured so that BWP and BW configurations configured UE specifically are aligned (1103). For example, a UE #0 and a UE #1 may have different BWP configurations and locations. In this case, BWs and BWPs of all UEs may be identically set to one for energy saving by reducing the BW used by the base station. Here, the BWP or BW for energy saving may be configured to be one or more and may be used to configure a BWP for each UE group. This is only an example, and the L1 signaling for adjusting the BW or BWP for energy saving is not limited to the above example.

In the description of the disclosure, higher layer signaling may be signaling corresponding to at least one of or a combination of signaling methods below:
Master information block (MIB);
System information block (SIB) or SIB X (X=1, 2, . . . );
Radio resource control (RRC); and/or
Medium access control (MAC) control element (CE).

Also, L1 signaling may be signaling corresponding to at least one of or a combination of signaling methods using following physical layer channels or signaling:
Physical downlink control channel (PDCCH);
Downlink control information (DCI);
UE-specific DCI;
Group common DCI;
Common DCI;
Scheduling DCI (for example, DCI used to schedule downlink or uplink data);
Non-scheduling DCI (for example, DCI not for scheduling downlink or uplink data);
Physical uplink control channel (PUCCH); and/or
Uplink control information (UCI).

Hereinafter, the above examples will be described through a plurality of embodiments of the disclosure, but the embodiments of the disclosure are not independent and one or more embodiments of the disclosure may be applied simultaneously or in combination.

Hereinafter, a discontinuous reception (DRX) alignment method through dynamic signaling for base station energy reduction in a 5G system will be described.

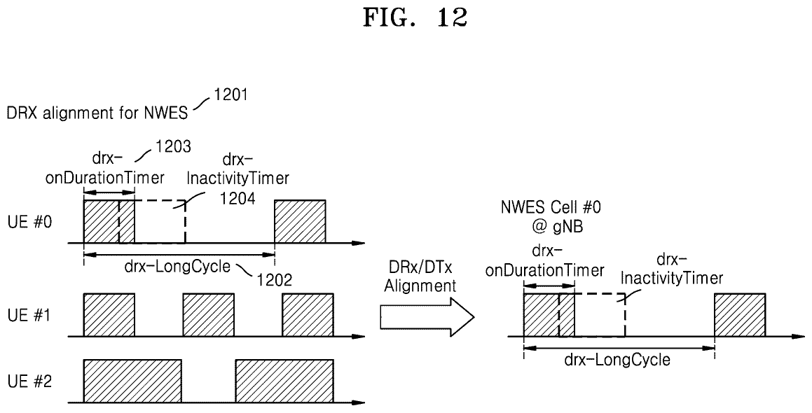

FIG. 12 illustrates an example of a method for reconfiguring DRX through dynamic signaling of a wireless communication system according to an embodiment of the disclosure.

Referring to FIG. 12, the base station may UE-specifically configure DRX through higher layer signaling. For example, different drx-LongCycle 1202 or drx-ShortCycle, drx-onDurationTimer 1203, and drx-InactivityTimer 1204 may be configured for the UEs. Then, the base station may configure a UE-specific DRX configuration through UE group-specific or cell-specific L1 signaling for energy saving (1201). Accordingly, the base station may achieve, for energy saving, a same effect as the UE saving power through DRX.

Hereinafter, a discontinuous transmission (DTx) operation for energy saving of the base station in a 5G system will be described.

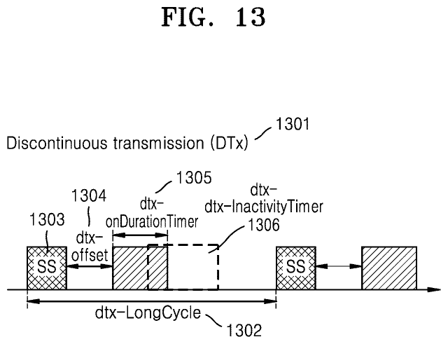

FIG. 13 illustrates an example of a DTx method for saving energy of the base station according to an embodiment of the disclosure.

Referring to FIG. 13, the base station may configure DTx for energy saving, through higher layer signaling (new SIB for DTx or RRC signaling) and L1 signaling (DCI). Here, the base station may configure the following parameters for a DTx operation: dtx-onDurationTimer 1305 used to transmit PDCCH for scheduling DL SCH or to transmit a reference signal for RRM measurement, beam management, and pathloss measurement, dtx-InactivityTimer 1306 used to receive PDSCH after receiving the PDCCH that schedules DL SCH, dtx-offset 1304 configuring an offset between the transmission of a synchronization signal 1303 and dtx-onDurationTimer 1305, and dtx-(Long) Cycle 1302 for DTx to periodically operate based on previous configuration information (configuration information for SS and configuration information for DTx). Also, the base station may configure information for SS (e.g., SSB transmission configuration information and CSI-RS or TRS transmission configuration information) through higher layer signaling and L1 signaling (DCI). Here, dtx-cycle may be configured in plural for a long cycle and a short cycle. During DTx, the base station considers a transmitting end to be in an off (or inactive) state, and accordingly, may not transmit DL CCH, SCH, and DL RS. In other words, the base station may transmit only downlink (PDCCH, PDSCH, RS, and the like) for SS, dtx-onDurationTimer, and dtx-InactivityTimer during DTx. SS-gapbetweenBurst or the number of SS bursts may be additionally configured as additional information of the configured SS.

Hereinafter, a gNB activation method through gNB wake-up signal (WUS) during an active mode of the base station for energy saving of the base station in a 5G system will be described.

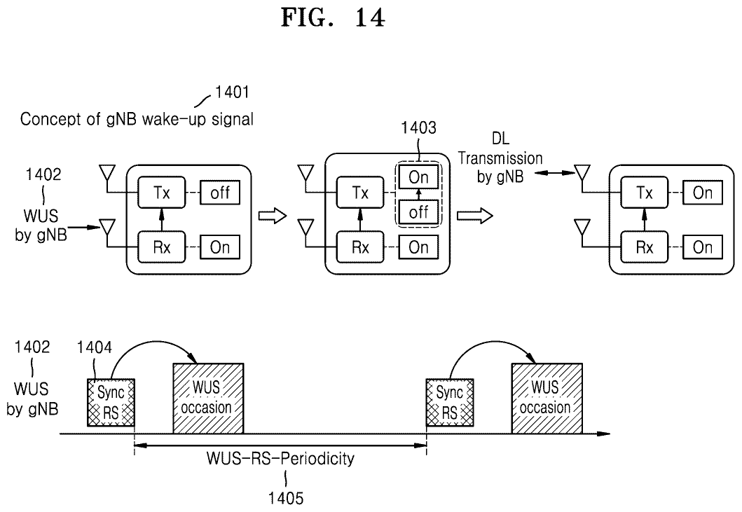

FIG. 14 illustrates an example of an operation of the base station according to a gNB wake-up signal according to an embodiment of the disclosure.

A gNB wake-up signal 1401 will be described with reference to FIG. 14. The base station may maintain a transmitting device end in an off (or inactive) state during an inactive mode (or sleep mode) of the base station for energy saving. Then, the base station may receive, from the UE, a gNB wake-up signal 1402 for activating the sleep mode of the base station. When a WUS is received through a reception (Rx) end from the UE, the gNB may change a transmission (Tx) end to an on (or active) state (1403). Then, the gNB may perform downlink transmission to the UE. In this case, the gNB may perform synchronization after Tx is turned on and perform control and data transmission. Various uplink signals, for example, a physical random access channel (PRACH), a scheduling request (SR PUCCH), and a PUCCH including acknowledgement, may be considered as a gNB WUS. Through such a method, the base station may save energy and at the same time, the UE may improve latency.

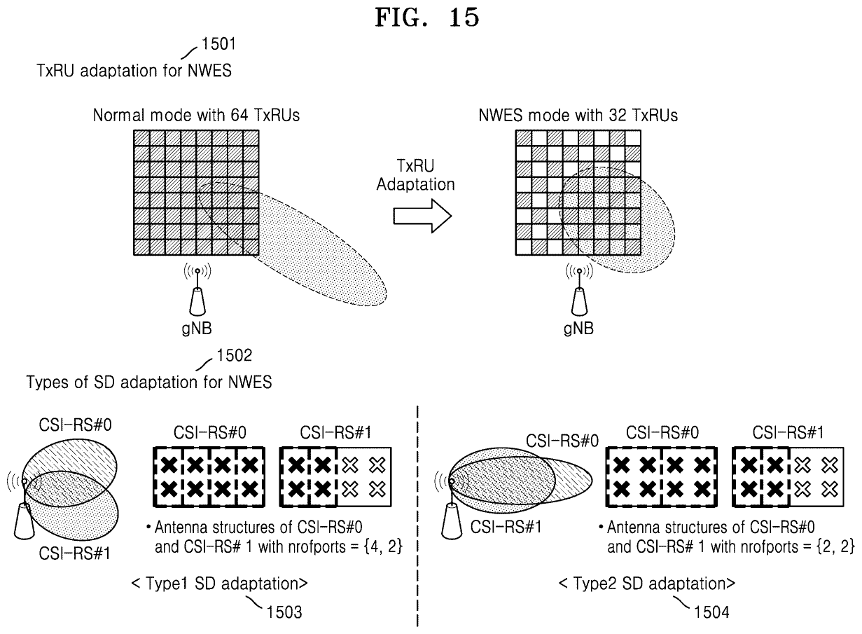

The base station may configure a WUS occasion for receiving a gNB WUS and sync RS for synchronization before the UE transmits the gNB WUS. Here, SSB, TRS, light SSB (PSS+SSS), consecutive SSBs, or new RS (continuous PSS+SSS) may be considered as the sync RS, and PRACH, PUCCH with SR, or a sequence based signal may be considered as a WUS. A sync RS 1404 for the UE to activate the inactive mode for energy saving of the base station, and the WUS occasion for receiving a WUS may be repeatedly transmitted with WUS-RS periodicity 1405. In FIG. 15, an embodiment of the disclosure is described with an example of 1-to-1 mapping of sync and WUS occasion, but the disclosure is not limited thereto. For example, sync and WUS occasion may be N-to-1 mapped, 1-to-N mapped, or N-to-N mapped.

Hereinafter, a method of dynamically turning on or off a spatial domain element (i.e., an antenna, PA, or transceiver units or transmission radio units (TxRUs)) of the base station for base station energy saving in a 5G system will be described.

FIG. 15 illustrates an example of an antenna adaptation method of the base station for saving energy in a wireless communication system according to an embodiment of the disclosure.

Referring to FIG. 15, the base station may adjust a TX antenna port per radio unit (RU) for network energy savings (NWES) (1501). For example, a power amplifier (PA) of the base station occupies most energy consumption of the base station, and thus, the gNB may turn off a Tx antenna for energy saving. Here, to determine whether it is possible to turn off the Tx antenna, the base station may refer/use reference signal received power (RSRP), a channel quality indicator (CQI), and reference signal received quality (RSRQ) of the UE. The base station may perform transmission by adjusting the number of activated Tx antennas per UE group or per UE. Here, the base station may configure the UE with information including at least one of beam information according to antenna on/off or reference signal information (e.g., at least one of a CSI resource, a resource set, or a CSI report), through higher layer signaling (e.g., RRC signaling) or DCI signaling. Also, the base station may reconfigure antenna information according to a change in BWP by configuring different pieces of antenna information for each BWP. The base station may receive CSI feedback from the UE to determine whether SD adaptation is possible. The base station may determine the SD adaptation (based on the CSI feedback). The base station may receive, from the UE, multi-feedback through antenna structure hypotheses of several antenna patterns for the SD adaptation.

In detail, the base station may apply a plurality of types (e.g., two types) of SD adaptation for energy saving (1502). For example, the plurality of types may include Type 1 SD adaptation 1503 and Type 2 SD adaptation 1504.

When Type 1 SD adaptation 1503 is applied, the base station may adapt the number of antenna ports while maintaining the number of physical antenna elements per antenna port (i.e., logical port). Here, RF characteristics (e.g., Tx power and beam) per port may be the same. Accordingly, the UE may perform measurement by combining CSI-RS of same ports during CSI measurement (e.g., layer 1-RSRP (L1-RSRP), layer 3-RSRP (L3-RSRP), or the like).

In another method, when Type 2 SD adaptation 1504 is applied, the base station may turn on/off the physical antenna element per port while having the same number of antenna ports (i.e., logical ports). Here, the RF characteristics per port may vary. The UE may perform measurement by distinguishing between CSI-RS of the same ports during CSI measurement. The base station may save energy through one or more of the plurality of types of SD adaptation methods including the above two types of SD adaptation methods.

Energy consumption of the base station may be saved through methods according to an embodiment of the disclosure. The methods according to an embodiment of the disclosure may be configured/used as one or may be simultaneously configured/used through a combination thereof.

According to an embodiment of the disclosure, a method by which the base station transmits a signal and a channel, which are always periodically transmitted, when necessary, so as to reduce energy consumption is provided. The base station may determine transmission of a signal that is always periodically transmitted, according to at least one of an uplink signal or the UE or determination of the base station. In detail, the base station may transmit a signal such as SSB or SIB1, which is always periodically transmitted, according to the uplink signal of the UE and the determination of the base station. In this regard, a configuration method for on-demand SSB and on-demand SIB1 transmission, and an SSB transmission pattern during transmission of the on-demand SSB may be provided. In the disclosure, energy saving, energy consumption reduction, and reduction of energy consumption may be interchangeably used and have a same meaning. Unless specifically stated otherwise, operations according to the disclosure may be applied to SIB other than SSB and SIB1. Also, the term “on-demand” is used to indicate that periodic transmission of a signal is adjusted according to the uplink signal of the UE and the determination of the base station, so as to reduce energy consumption of the base station, and may be replaced with another term having a same meaning.

### First Embodiment of Disclosure

According to a first embodiment of the disclosure, a method by which the base station configures on-demand SSB and SIB1 for on-demand SSB and SIB application for energy saving is provided.

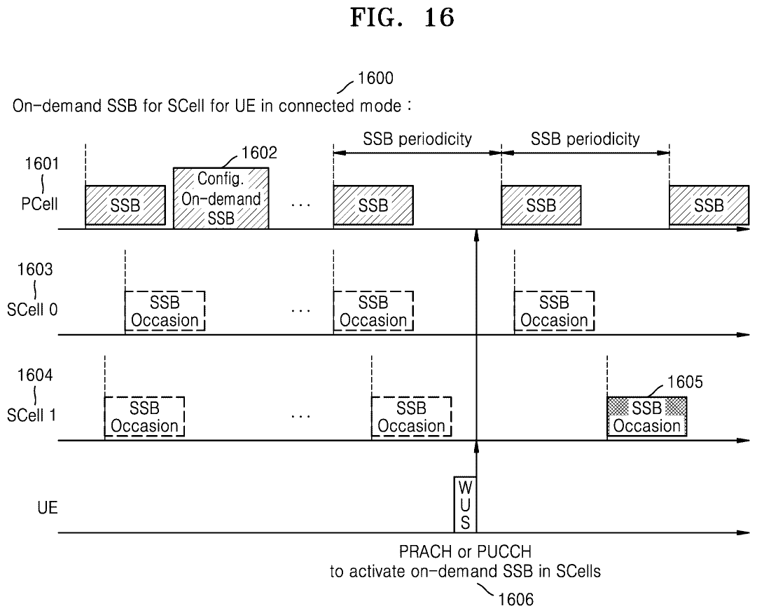

FIG. 16 illustrates an example of an on-demand SSB operations of the base station and the UE according to an embodiment of the disclosure.

Referring to FIG. 16, the base station may apply the on-demand SSB operation to one or multiple SCells during a CA operation. In detail, the base station may periodically perform SSB transmission in a PCell 1601. The base station may configure the UE with an on-demand SSB for SCells 1603 and 1604 through at least one of higher layer signaling (e.g., RRC or MAC CE) or L1 signaling or a combination thereof. The base station according to an embodiment of the disclosure may provide, to the UE, the on-demand SSB configuration for the SCells 1603 and 1604 through higher layer signaling and L1 signaling. For example, the base station may configure the UE with the on-demand SSB in the PCell 1601 through RRC signaling 1602. Then, based on the configured information, the UE may trigger SSB transmission of SCell #1 1604 through a WUS through an uplink channel (e.g., PUCCH or PRACH) 1606. Next, the base station may transmit SSB burst 1605 on the SCell #1 1604 after receiving the WUS. An on-demand SSB configuration and SCell configuration method for the above operations may be configured through one or a combination of the above methods, and SCell activation/deactivation may be determined based on such configuration.

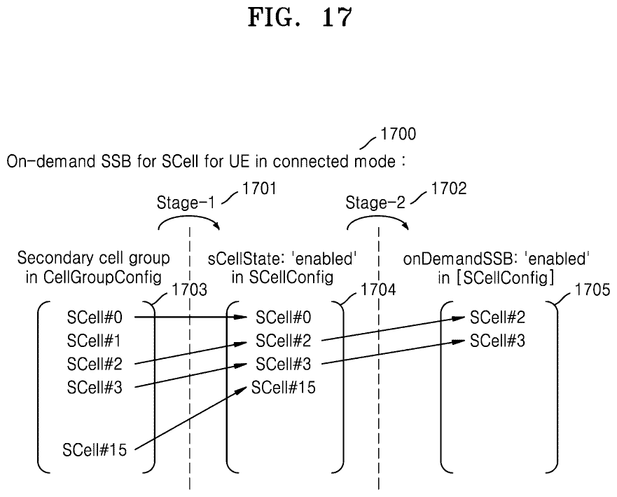

FIG. 17 illustrates an example of an SCell activation/deactivation and on-demand SSB configuration method for the base station according to an embodiment of the disclosure.

Referring to FIG. 17, the base station may configure a secondary cell group including candidate Scells through higher layer signaling (e.g., RRC signaling) (1703). Then, the base station may activate or deactivate an SCell through higher layer signaling for each UE (1704). In detail, the base station may configure sCellState of RRC signaling SCellconfig as enable or may activate or deactivate one or a plurality of SCells through MAC CE signaling. Then, for the activated SCell, an on-demand operation may be configured through at least one of RRC signaling, MAC CE signaling, or L1 signaling or through a combination of two or more signalings thereof (1705). Here, the on-demand operation may be configured during a process of activating the SCell or together with SCell activation in stage-1 1701. Also, the configuring of the on-demand operation may be applied only on stage-2 1702, and in this case, the on-demand operation may be configured through sCell-config for the activated SCell or MAC CE or L1 signaling (e.g., group common DCI, cell common DCI, or UE-specific DCI). The configuring of the on-demand operation may be activated or deactivated simultaneously with the SCell activation.

Through above methods, the base station may configure and instruct the SCell activation/deactivation and the on-demand operation. Then, the UE may determine SSB reception and WUS transmission according to the on-demand operation in the SCell, based on the configuration information.

Hereinafter, methods for SCell activation/deactivation and on-demand configuration of the disclosure are provided. The base station may configure the UE with the on-demand operation including SCell activation/deactivation by using one or a combination of the above methods.

### [Configuration 1]

In Configuration 1 according to an embodiment of the disclosure, the base station may configure configuration information and activation for an on-demand operation in SCell through RRC signaling, for energy saving.

The base station may configure the UE with SCell activation/deactivation and on-demand SSB or SIB1 operation activation/deactivation, through RRC signaling.

For example, the on-demand operation may be configured through sCellConfig of RRC signaling as in Table 13.

```
TABLE 13
sCellConfig ::= SEQUENCE {
  sCellIndex SCellIndex,
  sCellConfigCommon ServingCellConfigCommon OPTIONAL, -- Cond SCellAdd
  sCellconfigDedicated ServingcellConfig OPTIONAL, -- Cond SCellAddMod
  ...,
  [[
  smtc SSB-MTC OPTIONAL -- Need S
  ]],
  [[
  sCellState-r16 ENUMERATED {activated} OPTIONAL, -- Cond SCellAddSync
  onDemandSSB-r18 ENUMERATED {activated) OPTIONAL
  onDemandSIB-r18 ENUMERATED {activated} OPTIONAL
  onDemand-r18 ENUMERATED {Disable, SSB, SIB, Both} OPTIONAL
  secondaryDRX-GroupConfig-r16 ENUMERATED {true} OPTIONAL -- Need S
  ]],
  [[
  preConfGapStatus-r17 BIT STRING (SIZE (maxNrofGapId-r17)) OPTIONAL, -- Cond
  PreConfigMG
  goodServingCellEvaluationBFD-r17 GoodServingCellEvaluation-r17 OPTIONAL, -- Need R
  sCellSIB20-r17 SetupRelease { SCellSIB20-r17 } OPTIONAL -- Need M
  ]],
  [[
  plmn-IdentityInfoList-r17 SetupRelease {PLMN-IdentityInfoList} OPTIONAL, -- Cond
  SCellSIB20-Opt
  npn-IdentityInfoList-r17 SetupRelease {NPN-IdentityInfolist-r16} OPTIONAL -- Cond
  SCellSIB20-Opt
  ]] }
```

The base station may configure the on-demand operation for energy saving of the base station as onDemandSSB-r18, onDemandSIB-r18, or onDemand-r18, through sCellConfig RRC configuration, thereby indicating whether to perform the on-demand operation in the SCell corresponding to sCellIndex. However, this is only an embodiment of the disclosure, and according to another embodiment of the disclosure, information about the on-demand operation may be configured by being included in sCellConfigCommon or sCellConfigDedicated. Also, configuration information (e.g., periodicity, a pattern, and the number of SSBs) used when the base station or UE starts transmission by activating on-demand SSB or SIB may be configured through individual RRC signaling. In addition, for SSB, RRC signaling in which a list of specific patterns is organized may be configured, and an SSB pattern for each SCell may be configured based on a pattern index of the list. A multi-pattern configuration method may be applied to the on-demand operation of another channel, such as SIB1. For example, the on-demand operation may be configured together with or independent from the SCell activation/deactivation information. For example, the configuration of the on-demand operation may be applied to SCell in which sCellState is configured as activated. On the other hand, the on-demand operation may be individually configured regardless of SCell activation, and when the gNB activates an SCell or when the UE activates an on-demand operation of a deactivated SCell through WUS transmission, an SCell activation operation may be performed together. Also, configuration information of the UE related to WUS transmission for requesting the on-demand operation and WUS pattern information may be configured through RRC signaling.

### [Configuration 2]

In Configuration 2 according to an embodiment of the disclosure, the base station may configure whether to active an on-demand operation on an SCell for one or multiple SCells for energy saving, through MAC CE signaling. Also, a pattern for the on-demand operation may be indicated on an SCell.

The base station may configure the UE with SCell activation/deactivation and on-demand SSB or SIB1 operation activation/deactivation individually or together, through MAC CE.

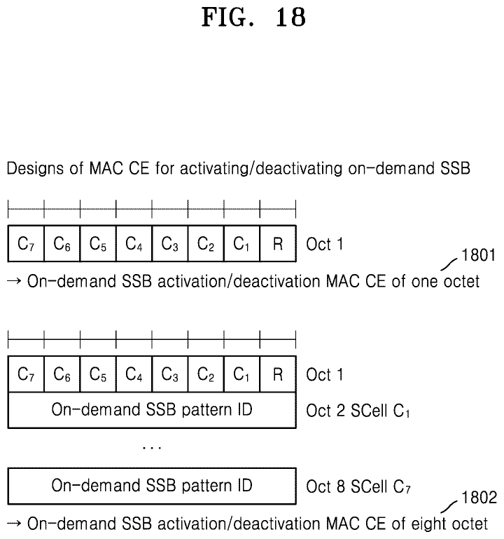

FIG. 18 illustrates an example of a MAC CE-based SCell activation/deactivation and on-demand SSB configuration method for the base station according to an embodiment of the disclosure.

Referring to FIG. 18, the base station may indicate on-demand SSB operation activation and on-demand SSB pattern for one or multiple SCells through MAC CE signaling. In detail, the base station may indicate the on-demand SSB operation activation for C₁ to C₇ SCells, through MAC CE having one octet (1801). Also, the base station may indicate the on-demand SSB operation activation for the C₁ to C₇ SCells, through MAC CE having multiple octets, and indicate the on-demand SSB pattern for each SCell (1802). The base station may select a pattern index from a pattern list configured through RRC signaling and indicate the on-demand SSB pattern. At this time, the on-demand SSB operation activation and SCell activation/deactivation may also be indicated through the MAC CE. According to an embodiment of the disclosure, a pattern index corresponding to each SCell may be indicated through the MAC CE, based on the pattern list configured through RRC signaling. In detail, through the MAC CE having eight octets, the on-demand SSB operation activation for the C₁ to C₇ SCells may be indicated in one octet and the pattern indexes for the C₁ to C₇ SCells may be indicated in 2 to 8 octets.

### [Configuration 3]

In Configuration 3 according to an embodiment of the disclosure, the base station may configure whether to active an on-demand operation on an SCell for one or multiple SCells for energy saving, through DIC. Also, an on-demand transmission pattern for the on-demand operation may be indicated on an SCell.

The base station may configure the UE with SCell activation/deactivation and on-demand SSB or SIB1 operation activation/deactivation individually or together, through DCI. Here, the DCI may be cell-specific DCI and thus group common DCI may be applied, or UE-specific DCI may be applied.

For example, a group-common DCI format as in Table 14 may be configured considering one or multiple SCells.

TABLE 14
DCI format 2_X is used for notifying on-demand SSB on one or more the activated SCell by RRC and MAC
CE.
The following information is transmitted by means of the DCI format 2_X with CRC scrambled by
Ondemad-RNTI:
- block number 1, block number 2,..., block number N
where the starting position of a block is determined in order of SCellIndex
The following fields defined for the block:

| | |
|---|---|
| - | On-demand SSB indication - 1 bit |
| - | On-demand pattern indication - N bit if higher layer parameter onDemandpatternList is |
| | configured |
| - | WUS occasion indication - N bit if higher layer parameter WUSResourceAllocationList is |
| | configured |

The size of DCI format 2_X is determined by the number of activated SCell.

As shown above, DCI includes multiple blocks for each SCell and in this case, the number of blocks may be determined according to candidate Scells belonging to a secondary cell group or the number of activated SCells. Also, the UE may determine the location of the block (i.e., a starting location of a bit) for each SCell, based on information configured through higher layer signaling (e.g., RRC signaling), or may determine the location of the block based on an SCell index. For example, when the SCell index is configured as {1, 2, 3, 7}, the SCell index may be assigned to block 1 to block 4 from a small SCell index. Here, each block may include a bit indicating whether to activate the on-demand operation in a corresponding SCell. For example, considering on-demand SSB and SIB, two bits, i.e., “00” may indicate deactivated, “01” may indicate on-demand SSB activation, “10” may indicate on-demand SIB1 activation, and “11” may indicate on-demand SSB and SIB1 activation. Also, a bit indicating WUS configuration information and on-demand pattern information may be included after the bit indicating the activation information. A configuration of the DCI format may be used in a combination of RRC signaling and MAC CE signaling. For example, when the on-demand operation is applied for a SIB other than an SIB1, a type of the SIB to which the on-demand operation is applied may be configured by using the DCI format through RRC signaling. A configuration of the block described above is only an example and does not limit the scope of the disclosure. In another example, a bit indicating whether to activate an SCell may be included in each block. Also, according to another embodiment of the disclosure, pieces of information that may be included in the block may be included in DCI in the form of a bitmap. For example, a configuration of the on-demand operation for one or more SCells may be provided in a bitmap and the size of the bitmap may be determined by the number of candidate Scells belonging to the secondary cell group or the number of activated SCells.

Through the embodiments of the disclosure, the base station may configure the UE with the on-demand operation and activate the on-demand operation, and may also indicate SCell activation/deactivation. Also, values of signalings are only examples and may be variously configured according to other embodiments of the disclosure.

Energy consumption of the base station may be reduced through the methods and embodiments of the disclosure described above. Also, the methods or embodiments of the disclosure may be simultaneously configured or performed through a combination thereof.

### Second Embodiment of Disclosure

According to a second embodiment of the disclosure, an on-demand SSB transmission method for energy saving of the base station is provided.

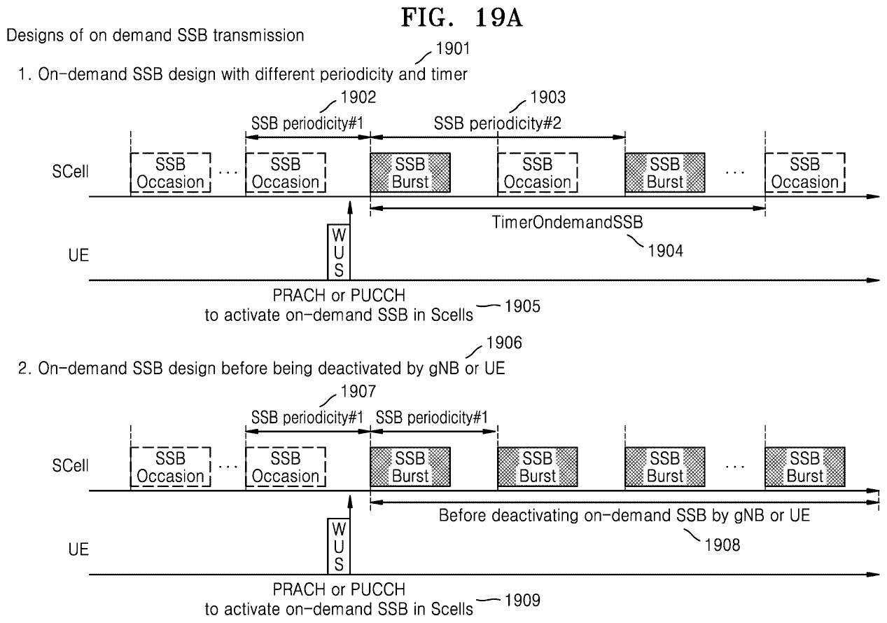

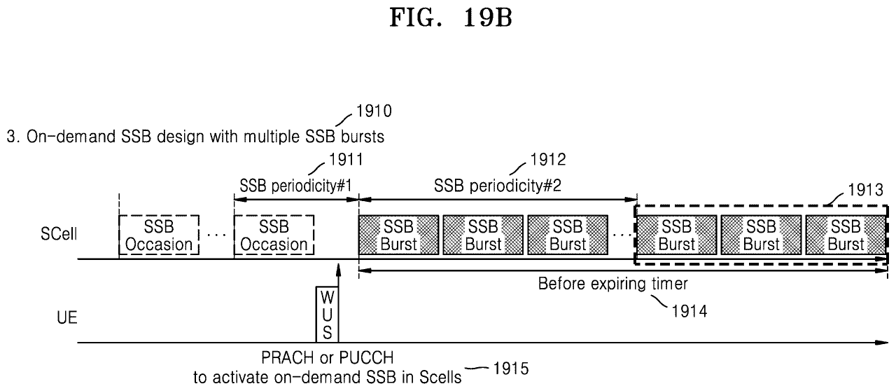

FIG. 19A and FIG. 19B illustrate on-demand SSB operations and SSB transmission patterns of the base station and the UE according to an embodiment of the disclosure.

Referring to FIG. 19a and FIG. 19b, the base station may apply the on-demand SSB operation to one or multiple SCells during a CA operation.

In detail, the base station may configure the UE with the on-demand SSB operation in the SCell through the method of the first embodiment of the disclosure. Then, the on-demand SSB operation may be performed through one or a combination of methods below.

### [Method 1]

In Method 1 according to an embodiment of the disclosure, a method by which the base station transmits an on-demand SSB for energy saving will be described. In detail, the base station may perform an on-demand SSB transmission operation based on different periodicities and timers after receiving WUS from the UE (1901).

Referring to FIG. 19A, the base station may configure and active an on-demand SSB operation on an SCell through the configuration and activation method described above with reference to the first embodiment of the disclosure. The base station may determine and configure an SSB occasion having periodicity #1 1902, based on the configuration information. Then, the base station may receive, from the UE, a WUS (e.g., PRACH or PUCCH) on a PCell or SCell (1905). Next, the base station may start transmitting an SSB in the SSB occasion, based on reception of the WUS. Here, the base station may transmit the on-demand SSB during a timer (e.g., TimerOndemandSSB 1904), based on a WUS reception time point (e.g., a WUS reception time point including a processing time for WUS decoding), a first SSB occasion transmission time point after WUS reception, or a first SSB transmission time point after the WUS reception. Here, the base station may perform SSB transmission having another periodicity #2 1903, based on a previously configured SSB occasion. The periodicity #2 1903 may be determined according to determination of the base station or according to an on-demand SSB pattern request from the UE. Through such a method, the base station and the UE may determine an SSB occasion, apply a dropping rule with another existing channel, and perform the on-demand SSB operation by applying different on-demand SSB patterns in the determined SSB occasions. Accordingly, the base station may save energy.

### [Method 2]

In Method 2 according to an embodiment of the disclosure, a method by which the base station transmits an on-demand SSB for energy saving will be described. In detail, the base station may perform an on-demand SSB transmission operation until a deactivation signal is received from the base station or UE after receiving WUS from the UE (1906).

Referring to FIG. 19a, the base station may configure and active the on-demand SSB operation on the SCell through the configuration and activation method described above with reference to the first embodiment of the disclosure. The base station may determine and configure an SSB occasion having periodicity #1 1907, based on the configuration information. Then, the base station may receive, from the UE, a WUS (e.g., PRACH or PUCCH) on a PCell or SCell (1909). Next, the base station may start transmitting an SSB in the SSB occasion, based on reception of the WUS. Here, the base station may start the on-demand SSB transmission in a first SSB occasion after WUS reception. Then, the base station may continuously perform the on-demand SSB transmission of the SCell according to the WUS from the UE and the determination of the base station, until deactivation. Through such a method, the base station and the UE may determine the SSB occasion based on the SSB configuration information configured in the SCell and apply a dropping rule on another existing channel. In the dropping rule, dropping is determined according to priority between channels defined in the standard. Then, the on-demand SSB is transmitted until a deactivation signal of the base station or UE, and the UE may receive the SSB until WUS transmission for deactivating the on-demand SSB and downlink signal reception for on-demand SSB transmission deactivation from the base station. Accordingly, the base station may save energy.

### [Method 3]

In Method 3 according to an embodiment of the disclosure, a method by which the base station transmits an on-demand SSB for energy saving will be described. The base station may determine and configure an SSB occasion having periodicity #1 1911. According to Method 3, the base station may perform an on-demand SSB transmission operation of continuously transmitting a multi-SSB burst after receiving a WUS from the UE (1910).

Referring to FIG. 19B, the base station may configure and active the on-demand SSB operation on the SCell through the configuration and activation method described above with reference to the first embodiment of the disclosure. The base station may configure an SSB pattern by using the configuration information. In detail, a configuration for continuously transmitting the SSB burst may be performed (1913). Here, a pattern used for the SSB burst is not limited to SSB transmission, and various patterns including CSI-RS or TRS may be considered. Also, an SSB burst pattern of repeatedly transmitting SSBs having a same SSB index may be considered. A multi-SSB burst 1913 transmitted continuously thereafter may be transmitted according to a WUS 1915 of the UE or SSB periodicity #2 1912 selected by the base station, and the SSB may be transmitted until a set timer expires (1914). The on-demand SSB transmission pattern of the SCell is considered only in a situation where the on-demand SSB is activated, and in an SCell in which the on-demand SSB deactivated, an SSB burst-based pattern used from existing Rel-15 may be used. Accordingly, an inefficient resource using method according to a fixed SSB occasion may be improved, and the UE may perform synchronization and automatic gain control (AGC) setting with shorter latency.

### Third Embodiment of Disclosure

According to a third embodiment of the disclosure, an on-demand SSB transmission method for energy saving of the base station may be provided. Hereinafter, flowcharts and block diagrams of the UE and base station for on-demand SSB transmission will be described.

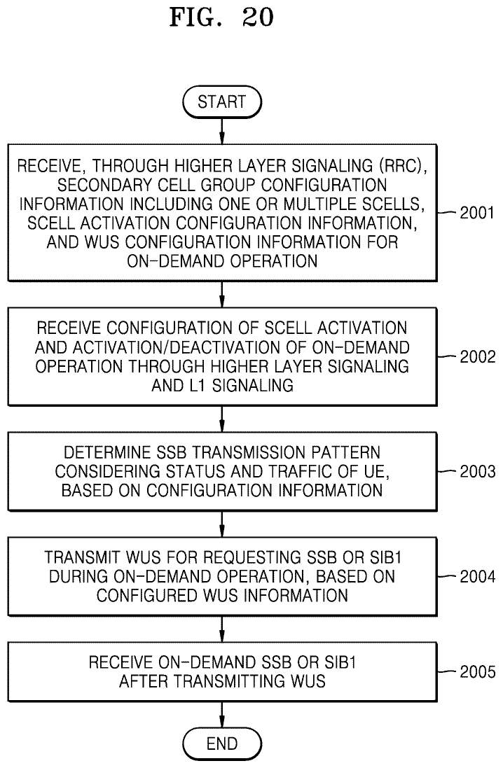

FIG. 20 illustrates an example of a flowchart of the UE for an energy saving method according to an embodiment of the disclosure.

In operation 2001, the UE may receive secondary cell group configuration information including one or multiple SCells, SCell activation configuration information, and WUS configuration information for an on-demand operation, from the base station through higher layer signaling (RRC), for energy saving.

In operation 2002, the UE may receive configuration of SCell activation and activation/deactivation of the on-demand operation through higher layer signaling and L1 signaling.

In operation 2003, the UE may determine an SSB transmission pattern considering a status and traffic of the UE, based on the configuration information.

In operation 2004, the UE may transmit a WUS for requesting SSB or SIB1 during the on-demand operation, based on the configured WUS information.

In operation 2005, the UE may receive an on-demand SSB or SIB1 after transmitting the WUS.

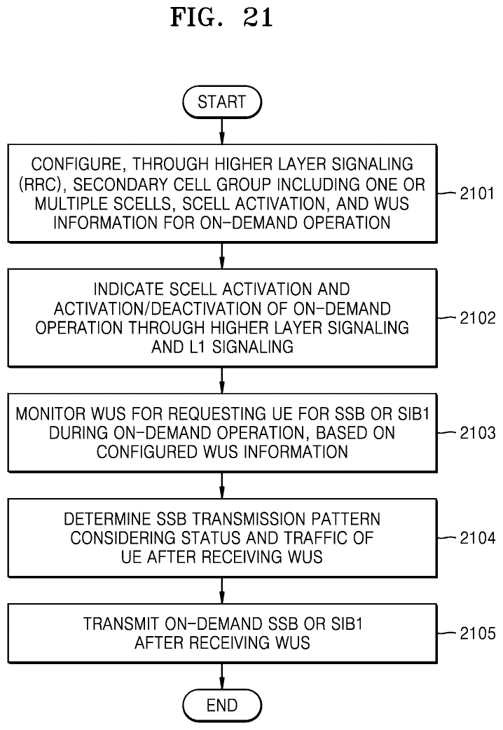

FIG. 21 illustrates an example of a flowchart of the base station for an energy saving method according to an embodiment of the disclosure.

In operation 2101, the base station may configure, through higher layer signaling (RRC), the UE with secondary cell group configuration information including one or multiple SCells, SCell activation configuration information, and WUS information for an on-demand operation, for energy saving of the base station.

In operation 2102, the base station may indicate the UE about SCell activation and activation/deactivation of the on-demand operation through higher layer signaling and L1 signaling.

In operation 2103, the base station may monitor a WUS from the UE so as to request SSB or SIB1 during the on-demand operation, based on the configured WUS information.

In operation 2104, after receiving the WUS, the base station may determine an SSB transmission pattern by considering a status and traffic of the UE.

In operation 2105, the base station may transmit an on-demand SSB or SIB1 after receiving the WUS.

The flowcharts described above illustrate methods that may be implemented in accordance with the principles of the disclosure, and various modifications may be made to the methods illustrated in the flowcharts of the present specification. For example, although illustrated as a series of operations, the various operations in each drawing may overlap, occur in parallel, occur in different orders, or occur multiple times. In another example, an operation may be omitted or replaced by another operation.

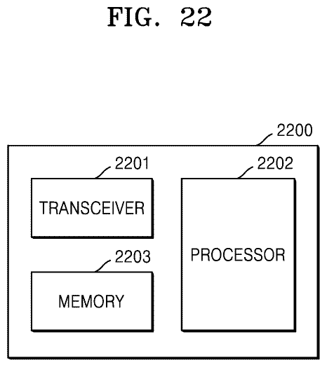

FIG. 22 illustrates an example of a terminal 2200 according to an embodiment of the disclosure.

Referring to FIG. 22, the terminal 2200 may include a transceiver 2201, a controller (e.g., a processor) 2202, and a storage (e.g., a memory) 2203. The transceiver 2201, the controller 2202, and the storage 2203 of the terminal 2200 may operate according to one or a combination of the methods according to the embodiments of the disclosure described above. However, the components of the terminal 2200 are not limited thereto. According to another embodiment of the disclosure, the terminal 2200 may include more or fewer components than those described above. In addition, in a specific case, the transceiver 2201, the controller 2202, and the storage 2203 may be implemented as a single chip.

According to an embodiment of the disclosure, the transceiver 2201 may include a transmitter and a receiver. The transceiver 2201 may transmit or receive signals to or from a base station. The signals may include control information and data. The transceiver 2201 may include a RF transmitter for up-converting and amplifying a frequency of a transmitted signal, and a RF receiver for amplifying low-noise and down-converting a frequency of a received signal. The transceiver 2201 may receive and output, to the controller 2202, a signal through a wireless channel, and transmit a signal output from the controller 2202 through the wireless channel.

The controller 2202 may control a series of processes such that the terminal 2200 operates according to the embodiment of the disclosure described above. For example, the controller 2202 may perform or control operations of the terminal 2200 for performing at least one or a combination of methods according to the embodiments of the disclosure. The controller 2202 may include at least one processor. For example, the controller 2202 may include a communication processor (CP) for controlling communications and an application processor (AP) for controlling a higher layer (e.g., an application).

The storage 2203 may store data or control information (e.g., information related to channel estimation using DMRS transmitted on PUSCH included in a signal obtained by the terminal 2200), and may include an area for storing data required for control by the controller 2202 and data generated during control by the controller 2202.

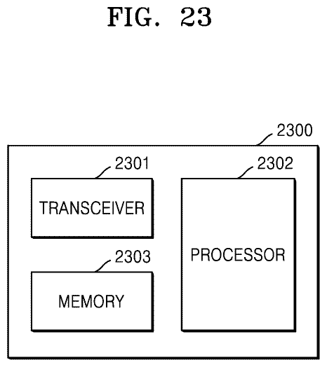

FIG. 23 illustrates an example of a base station 2300 according to an embodiment of the disclosure.

Referring to FIG. 23, the base station 2300 may include a transceiver 2301, a controller (e.g., a processor) 2302, and a storage (e.g., a memory) 2303. The transceiver 2301, the controller 2302, and the storage 2303 of the base station 2300 may operate according to one or a combination of the methods according to the embodiments of the disclosure described above. However, the components of the base station 2300 are not limited thereto. According to another embodiment of the disclosure, the base station 2300 may include more or fewer components than those described above. In addition, in a specific case, the transceiver 2301, the controller 2302, and the storage 2303 may be implemented as a single chip.

According to an embodiment of the disclosure, the transceiver 2301 may include a transmitter and a receiver. The transceiver 2301 may transmit or receive signals to or from a terminal. The signals may include control information and data. The transceiver 2301 may include a RF transmitter for up-converting and amplifying a frequency of a transmitted signal, and a RF receiver for amplifying low-noise and down-converting a frequency of a received signal. The transceiver 2301 may receive and output, to the controller 2302, a signal through a wireless channel, and transmit a signal output from the controller 2302 through the wireless channel.

The controller 2302 may control a series of processes such that the base station 2300 operates according to the embodiment of the disclosure described above. For example, the controller 2302 may perform or control operations of the base station 2300 for performing at least one or a combination of methods according to the embodiments of the disclosure. The controller 2302 may include at least one processor. For example, the controller 2302 may include a CP for controlling communications and an AP for controlling a higher layer (e.g., an application).

The storage 2303 may store control information (e.g., information related to channel estimation generated by using DMRS transmitted on PUSCH determined by the base station 2300), data, and control information or data received from the terminal, and include an area for storing data required for control by the controller 2302 and data generated during control by the controller 2302.

According to an embodiment of the disclosure, unnecessary energy consumption of a base station may be reduced by transmitting a signal and channel (e.g., SSB or SIB1), which are always periodically transmitted, only when necessary, through an on-demand operation of the base station, in a 5G mobile communication system. In this regard, an on-demand operation configuration method and an on-demand SSB transmission method of the base station may be provided.

The effects obtainable in the disclosure are not limited to the above-mentioned effects, and other effects not mentioned may be clearly understood by one of ordinary skill in the art from the description of the disclosure.

Although the drawings illustrate different examples of UEs/base stations, various changes may be made to the drawings. For example, a UE/base station may include any number of components in any suitable arrangement. In general, the drawings do not limit the scope of the disclosure to any particular setting. Furthermore, while the drawings illustrate an operating environment in which various UE/base station features described in the patent document may be used, such features may be used in any other suitable system.

The disclosure has been described with reference to embodiments of the disclosure, various changes and modifications may be presented to one of ordinary skill in the art. It is intended that the disclosure covers such changes and modifications within the scope of the appended claims. The description in the present application should not be construed as implying that any specific element, operation, or function is essential to the scope of the claim. The scope of the patented subject matter is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station, configuration information for an on-demand operation of at least one secondary cell;
identifying that an on-demand operation of a secondary cell among the at least one secondary cell is triggered; and
receiving, based on the configuration information, an on-demand synchronization signal block (SSB) of the secondary cell.

2. The method of claim 1, wherein the configuration information includes a periodicity of the on demand SSB.

3. The method of claim 1, further comprising receiving an indication of the on-demand operation of the secondary cell via at least one of a radio resource control (RRC) signaling, a medium access control (MAC) control element (CE), or downlink control information (DCI).

4. The method of claim 1, further comprising receiving a deactivation indication of the on-demand operation,
wherein the on-demand SSB of the secondary cell is received before receiving the deactivation indication.

5. The method of claim 1, further comprising identifying a timer associated with the on-demand operation,
wherein the on-demand SSB of the secondary cell is received until the timer expires.

6. A method performed by a base station in a wireless communication system, the method comprising:
transmitting, to a user equipment (UE), configuration information for an on-demand operation of at least one secondary cell; and
transmitting, based on the configuration information, an on-demand synchronization signal block (SSB) of a secondary cell that is identified among the at least one secondary cell.

7. The method of claim 6, wherein the configuration information includes a periodicity of the on demand SSB.

8. The method of claim 6, further comprising transmitting an indication of the on-demand operation of the secondary cell via at least one of a radio resource control (RRC) signaling, a medium access control (MAC) control element (CE), or downlink control information (DCI).

9. The method of claim 6, further comprising transmitting a deactivation indication of the on-demand operation,
wherein the on-demand SSB of the secondary cell is transmitted before transmitting the deactivation indication.

10. The method of claim 6, wherein the on-demand SSB of the secondary cell is transmitted to the UE until a timer associated with the on-demand operation expires.

11. A user equipment (UE) in a wireless communication system, the UE comprising:
a transceiver; and
at least one processor coupled with the transceiver and configured to:
receive, from a base station, configuration information for an on-demand operation of at least one secondary cell,
identify that an on-demand operation of a secondary cell among the at least one secondary cell is triggered, and
receive, based on the configuration information, an on-demand synchronization signal block (SSB) of the secondary cell.

12. The UE of claim 11, wherein the configuration information includes a periodicity of the on demand SSB.

13. The UE of claim 11, wherein the at least one processor is further configured to receive an indication of the on-demand operation of the secondary cell via at least one of a radio resource control (RRC) signaling, a medium access control (MAC) control element (CE), or downlink control information (DCI).

14. The UE of claim 11, wherein the at least one processor is further configured to receive a deactivation indication of the on-demand operation, and
wherein the on-demand SSB of the secondary cell is received before receiving the deactivation indication.

15. The UE of claim 11, wherein the at least one processor is further configured to identify a timer associated with the on-demand operation, and
wherein the on-demand SSB of the secondary cell is received until the timer expires.

16. A base station in a wireless communication system, the base station comprising:
a transceiver; and
at least one processor coupled with the transceiver and configured to:
transmit, to a user equipment (UE), configuration information for an on-demand operation of at least one secondary cell, and
transmit, based on the configuration information, an on-demand synchronization signal block (SSB) of a secondary cell that is identified among the at least one secondary cell.

17. The base station of claim 16, wherein the configuration information includes periodicity of the on demand SSB.

18. The base station of claim 16, wherein the at least one processor is further configured to transmit an indication of the on-demand operation of the secondary cell via at least one of a radio resource control (RRC) signaling, a medium access control (MAC) control element (CE), or downlink control information (DCI).

19. The base station of claim 16, wherein the at least one processor is further configured to transmit a deactivation indication of the on-demand operation, and
wherein the on-demand SSB of the secondary cell is transmitted before transmitting the deactivation indication.

20. The base station of claim 16, wherein the on-demand SSB of the secondary cell is transmitted to the UE until a timer associated with the on-demand operation expires.
